(19) United States
(12) Patent Application Publication
(10) Pub. No.: US 2026/0094120 A1
(43) Pub. Date: Apr. 2, 2026

(54) CONTENT-CREATION TEMPLATE RECOMMENDATION SYSTEM FOR CONTENT COLLABORATION SERVICE

(71) Applicant: Atlassian Pty Ltd., Sydney (AU)

(72) Inventors: Yingjie Ma, Orange, CA (US); Qinlong Luo, Alpharetta, GA (US); Eric Kang, Los Angeles, CA (US); Likhita Rav Bathineni, San Francisco, CA (US); Michael Johnson, Denver, CO (US); Fan Jiang, Mountain View, CA (US); Akhil Kaza, Seattle, WA (US)

(21) Appl. No.: 18/900,396

(22) Filed: Sep. 27, 2024

(51) Int. Cl. G06Q 10/101

(52) U.S. Cl. CPC G06Q 10/101

(57) ABSTRACT

A method includes selecting a template ranking engine for ranking a set of candidate content-creation templates based at least in part on a type of an available dataset for a user. The selecting may include, if the available dataset includes semantic content from a referring source, selecting a first template ranking engine, if the available dataset does not include semantic content from a referring source and does include content collaboration service usage data associated with a user account of the content collaboration service, selecting a second template ranking engine, and if the available dataset includes portal activity data of the user during a user interaction session with the portal of the content collaboration service and does not include semantic content from a referring source and does not include content collaboration service usage data associated with a user account of the content collaboration service, selecting a third template ranking engine.

### TECHNICAL FIELD

The present disclosure is generally directed to collaborative document management and communication systems and, more specifically, to systems and methods for providing customized content-creation template recommendations to users.

### BACKGROUND

Modern electronic devices facilitate a myriad of uses, both for business and personal endeavors. For example, electronic devices like personal computers, tablets, mobile phones, are used in both business and personal contexts for creating and storing documents, writing computer code, communicating with other individuals (e.g., via email, chat services, voice and video calls, etc.), and the like. Collaborative computer-based systems, such as shared document systems, may be used by organizations to allow users to create, store, and access files and other content items. Due to the vast numbers and types of content items that may be created and stored in such systems, as well as the vast number of people who may access and use such systems, it may be cumbersome to create new documents and to maintain consistency in document styles and appearance across an organization.

### SUMMARY

A method may include, during a user interaction session with a portal of a content collaboration service, receiving a portal page request from a user, the portal page request referring to a portal page configured to display a set of recommended content-creation templates to the user. The method may further include assigning a user identifier associated with the user to a user class, the user class selected from a set of user classes including a first user class indicating that the portal page request includes semantic content from a referring source registered with the content collaboration service, a second user class indicating that the user is associated with a user account of any software platform of the set of software platforms of the content collaboration service and that the portal page request does not include semantic content from a referring source registered with the content collaboration service, and a third user class indicating that the user is not associated with a user account of any software platform of the set of software platforms of the content collaboration service and that the portal page request does not include semantic content from a referring source registered with the content collaboration service. The method may further include determining a platform intent based at least in part on the user class, the platform intent indicating preference for a software platform of the set of software platforms associated with the content collaboration service, the determining including, in accordance with a determination that the user identifier is assigned to the first user class, determining the platform intent based at least in part on the semantic content from the referring source, in accordance with a determination that the user identifier is assigned to the second user class, determining the platform intent based at least in part on content collaboration service usage data associated with the user account of the user, and in accordance with a determination that the user identifier is assigned to the third user class, determining the platform intent based at least in part on portal activity data of the user during the user interaction session with the portal of the content collaboration service. The method may further include selecting a software platform of the set of software platforms based at least in part on the determined platform intent, identifying a set of candidate content-creation templates associated with the selected software platform, and ranking the set of candidate content-creation templates based at least in part on the user class, the ranking including, in accordance with a determination that the user identifier is assigned to the first user class, ranking the set of candidate content-creation templates based at least in part on the semantic content from the referring source, in accordance with a determination that the user identifier is assigned to the second user class, ranking the set of candidate content-creation templates based at least in part on the content collaboration service usage data associated with a user account of the user, and in accordance with a determination that the user identifier is assigned to the third user class, ranking the set of candidate content-creation templates based at least in part on the portal activity data of the user during the user interaction session with the portal of the content collaboration service. The method may further include causing identifiers of at least a portion of the set of candidate content-creation templates to be displayed on the portal page according to the ranking. The content collaboration service usage data associated with the user account of the user may include a content-creation template usage history for the selected software platform. The semantic content from the referring source may include one or more search query terms provided by the user to the referring source. The semantic content from the referring source may include text content that was displayed to the user by the referring source. The portal activity data of the user during the user interaction session with the portal of the content collaboration service may include text content from a site visited during the user interaction session.

The method may further include, in response to a user selection of a displayed identifier of a candidate content-creation template of a collaborative document platform, in accordance with a determination that the user identifier is associated with a user account of the collaborative document platform, displaying a content-creation template interface in the collaborative document platform in an authenticated session, and in accordance with a determination that the user identifier is not associated with a user account of the collaborative document platform, displaying an account registration interface for the collaborative document platform. The method may further include generating a content item for the collaborative document platform, the content item including the content-creation template, displaying the content item in the content-creation template interface, receiving a user modification of the content item, and storing the user modified content item in association with the collaborative document platform.

The method may further include, after assigning the user identifier to the third user class, authenticating the user with respect to the content collaboration service, and in response to authenticating the user with respect to the content collaboration service reassigning the user identifier to the second user class, reranking the set of candidate content-creation templates based at least in part on the content collaboration service usage data associated with the user account of the user, and causing identifiers of at least a portion of the reranked set of candidate content-creation templates to be displayed on the portal page according to the reranking.

A method may include, during a user interaction session with a portal of a content collaboration service, receiving a portal page request from a user, the portal page request referring to a portal page configured to display a set of recommended content-creation templates for a software platform to the user, and assigning a user identifier associated with the user to a user class. The user class may be selected from a set of user classes including a first user class indicating that the portal page request includes search query terms from a referring source, a second user class indicating that the user is associated with a user account of any software platform of the set of software platforms of the content collaboration service and that the portal page request does not include search query terms from a referring source, and a third user class indicating that the user is not associated with a user account of any software platform of the set of software platforms of the content collaboration service and that the portal page request does not include search query terms from the referring source. The method may further include identifying a set of candidate content-creation templates associated with the software platform, and ranking the set of candidate content-creation templates. Ranking the set of candidate content-creation templates may include, in accordance with a determination that the user identifier is assigned to the first user class, ranking the set of candidate content-creation templates based at least in part on the search query terms from the referring source, in accordance with a determination that the user identifier is assigned to the second user class, ranking the set of candidate content-creation templates based at least in part on content collaboration service usage data associated with the user account, and in accordance with a determination that the user identifier is assigned to the third user class, ranking the set of candidate content-creation templates based at least in part on portal activity data of the user during the user interaction session with the portal of the content collaboration service. The method may further include causing identifiers of at least a portion of the set of candidate content-creation templates to be displayed on the portal page according to the ranking. The portal activity data of the user during the user interaction session with the portal of the content collaboration service may include textual content from a set of sites visited by the user during the user interaction session.

Ranking the set of candidate content-creation templates based at least in part on the content collaboration service usage data associated with the user account may include ranking the set of candidate content-creation templates based at least in part on a dataset that includes an identifier of at least one content-creation template that was previously used by the user and at least one content item created by the user.

Ranking the set of candidate content-creation templates based at least in part on the search query terms from the referring source may include identifying respective semantic content associated with respective content-creation templates, determining respective semantic similarity scores between the search query terms and the respective semantic content associated with the respective candidate content-creation templates, and ranking the set of candidate content-creation templates based on the semantic similarity scores.

The method may further include, in response to a user selection of a displayed identifier of a candidate content-creation template of a collaborative document platform, in accordance with a determination that the user identifier is associated with a user account of the collaborative document platform, displaying a content-creation template interface in the collaborative document platform in an authenticated session, and in accordance with a determination that the user identifier is not associated with a user account of the collaborative document platform, displaying an account registration interface for the collaborative document platform.

Ranking the set of candidate content-creation templates may further include, in accordance with a determination that the user identifier is assigned to the second user class, ranking the set of candidate content-creation templates further based at least in part on at least one of a team affiliation or a job title associated with the user account. Ranking the set of candidate content-creation templates based at least in part on the search query terms from the referring source comprises ranking the set of candidate content-creation templates with a first template ranking engine configured to rank the set of candidate content-creation templates using a first recommendation model, ranking the set of candidate content-creation templates based at least in part on content collaboration service usage data associated with the user account comprises ranking the set of candidate content-creation templates with a second template ranking engine configured to rank the set of candidate content-creation templates using a second recommendation model different from the first recommendation model, and ranking the set of candidate content-creation templates based at least in part on portal activity data of the user during the user interaction session with the portal of the content collaboration service may include ranking the set of candidate content-creation templates with a third template ranking engine configured to rank the set of candidate content-creation templates using a third recommendation model different from the first and from the second ranking model. The first recommendation model may include a semantic similarity model, the second recommendation model may include a hybrid matrix factorization model, and the third recommendation model may include a sequential recommendation model.

A method may include, during a user interaction session with a portal of a content collaboration service, receiving a portal page request from a user, the portal page request referring to a portal page configured to display a set of recommended content-creation templates for a software platform to the user, identifying a set of candidate content-creation templates associated with the software platform, and selecting a template ranking engine for ranking the set of candidate content-creation templates based at least in part on a type of an available dataset for the user. The selecting may include, in accordance with a determination that the available dataset for the user includes semantic content from a referring source, selecting a first template ranking engine, in accordance with a determination that the available dataset for the user does not include semantic content from a referring source and does include content collaboration service usage data associated with a user account of any software platform of the set of software platforms of the content collaboration service, selecting a second template ranking engine, and in accordance with a determination that the available dataset for the user includes portal activity data of the user during a user interaction session with the portal of the content collaboration service and does not include semantic content from a referring source and does not include content collaboration service usage data associated with a user account of any software platform of the set of software platforms of the content collaboration service, selecting a third template ranking engine. The method may further include ranking the set of candidate content-creation templates using the selected template ranking engine, wherein the first template ranking engine is configured to rank the set of candidate content-creation templates based at least in part on the semantic content from the referring source, the second template ranking engine is configured to rank the set of candidate content-creation templates based at least in part on the content collaboration service usage data associated with the user account, and the third template ranking engine is configured to rank the set of candidate content-creation templates based at least in part on the portal activity data of the user during the user interaction session with the portal of the content collaboration service, and causing identifiers of at least a portion of the set of candidate content-creation templates to be displayed on the portal page according to the ranking.

The portal page may be configured to display identifiers of a set of recommended content-creation templates for the set of software platforms, the set of software platforms including the software platform. The method may further include, in response to receiving the portal page request from the user, determining a platform intent based at least in part on the type of available dataset for the user, the platform intent indicating preference for a software platform of the set of software platforms associated with the content collaboration service. The determining may include, in accordance with the determination that the available dataset for the user includes semantic content from a referring source, determining the platform intent based at least in part on the semantic content from the referring source, in accordance with a determination that the available dataset for the user does not include semantic content from a referring source and does include content collaboration service usage data associated with a user account of the content collaboration service, determining the platform intent based at least in part on the content collaboration service usage data associated with the user account, and in accordance with a determination that the available dataset for the user includes portal activity data of the user during a user interaction session with the portal of the content collaboration service and does not include semantic content from a referring source and does not include content collaboration service usage data associated with a user account of the content collaboration service, determining the platform intent based at least in part on the portal activity data of the user during the user interaction session with the portal of the content collaboration service.

Ranking the set of candidate content-creation templates based at least in part on the content collaboration service usage data associated with the user account may include ranking the set of candidate content-creation templates based at least in part on a dataset that includes an identifier of at least one content-creation template that was previously used by the user and at least one content item created by the user.

The semantic content from the referring source may include at least one of a search query provided by the user to the referring source or text content that was displayed to the user by the referring source.

The method may further include, in response to a user selection of a displayed candidate content-creation template of a collaborative document platform, in accordance with a determination that the user is associated with a user account of the collaborative document platform, displaying a content-creation template interface in the collaborative document platform in an authenticated session, and in accordance with a determination that the user is not associated with a user account of the collaborative document platform, displaying a trial account registration interface for the collaborative document platform.

### BRIEF DESCRIPTION OF THE DRAWINGS

In the drawings:

FIG. 1 depicts an example system in which various features of the present disclosure may be implemented.

FIG. 2A depicts an example process for providing content-creation template recommendations to users of a portal of a content collaboration service.

FIG. 2B depicts a flow chart of an example technique for selecting a template ranking engine.

FIG. 3 depicts example user classes and associated datasets for determining content-creation template recommendations for users of a portal of a content collaboration service.

FIGS. 4A-4D depict example portal pages of a portal service of a content collaboration service.

FIGS. 5A-5C depict example portal pages of a portal service of a content collaboration service.

FIG. 6A depicts an example user interface of a software platform, displaying an example content-creation template.

FIG. 6B depicts an example portal page of a portal service of a content collaboration service.

FIG. 6C depicts an example trial account registration interface.

FIG. 7 depicts a sample electrical block diagram of an electronic device that may perform the operations described herein.

While the invention as claimed is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION OF THE EMBODIMENTS

In the following description numerous specific details are set forth in order to provide a thorough understanding of the claimed invention. It will be apparent, however, that the claimed invention may be practiced without these specific details. In some instances, well-known structures and devices are shown in block diagram form in order to avoid unnecessary obscuring.

The present disclosure is generally directed to systems and methods for providing intelligent content-creation template recommendations to users to a portal of a content collaboration service. In particular, a content collaboration service (CCS) may allow users to generate, store, and access many different types of content items, which may also be referred to as documents. These may include, for example, marketing reports, financial reports, blog posts, frequently-asked-question documents, engineering timelines, white papers, marketing plans, project plans, checklists, issue records, codebases, and so forth. In order to improve the efficiency and convenience of the CCS, content-creation templates may be provided to assist users in generating content items. Content-creation templates may provide pre-established formatting, predefined text input fields, graphics, layouts, sample text, instructions, or the like.

Content-creation templates may help users generate content items faster and more efficiently and may help ensure uniformity and consistency of content-creation templates across a department or organization.

A portal of a CCS may provide recommendations of content-creation templates to users of the portal. Recommendations of content-creation templates may help users quickly identify and access available templates, and may alert the user to the existence of templates of which they may not otherwise be aware. However, given the extensive functionality of a CCS and the large number of available content-creation templates, it may not be efficient or desirable to present all available templates, or to select a subset of templates that are not tailored to the particular interests or uses of the user.

Accordingly, the instant application describes techniques for providing customized or tailored recommendations of content-creation templates to users to a portal of a CCS. However, not every user will be associated with the same type of data from which customized template recommendations may be generated. For example, some users may be registered users that are associated with extensive usage history and account information with the CCS. In such cases, template recommendations may be customized based on the user's usage history (e.g., content item creation and/or access histories), their job title, team affiliations, and the like. For users that are not registered users with the CCS (or for which account and/or usage history is unavailable), template recommendation customizations may be based on other factors, which may depend on the particular type of data or dataset that is available for that user. For example, a user who accessed the portal via a referring source (such as a search engine, webpage, internet advertisement, or the like), information may be provided to the CCS portal by the referring source. Such information may include search keywords that were inputted by the user to the referring source, text content from the referring source (e.g., text that was displayed to the user), metadata associated with the referring source, and the like. Yet other users may access the portal directly and/or without any data being provided by a referring source. In such cases, the data available for that user, from which template customizations may be generated, may be portal activity data of the user during a user interaction session with the portal of the CCS. Such information may include page view history, cursor position information, and the like.

Since different types of datasets are available for different classes of users of a portal, different ranking engines (which may employ different ranking algorithms) may be used to identify the template recommendations for different classes of users. More particularly, a ranking engine may be optimized or otherwise calibrated to determine template recommendations using a particular type of dataset. Accordingly, in order to provide the most accurate or useful recommendations, different ranking engines may be used based on the available dataset for a user (which corresponds to the user class of the user). Thus, if a user is a first class of user (e.g., corresponding to the user being associated with semantic content from a referring source), the recommendation system described herein may select a first ranking engine that is tailored to generate recommendations based on semantic content from the referring source. As another example, if a user is a second class of user (e.g., corresponding to the user having an account with the CCS and not being associated with semantic content from a referring source), the recommendation system may select a different ranking engine that is tailored to generate recommendations based on usage data associated with the user account. As yet another example, if a user is a third class of user (e.g., corresponding to the user not having an account with the CCS and not being associated with semantic content from a referring source), the recommendation system may select a different ranking engine that is tailored to generate recommendations based on portal activity data during a user interaction session. Accordingly, the template recommendations for each user may be generated using a unique engine that is selected based on the properties of the user and/or their available datasets.

In a sophisticated CCS that provides multiple different software platforms that provide different functionality, content-creation templates may be available in each of the software platforms. Thus, an issue tracking software platform may include content-creation templates for use in the issue tracking platform, and a collaborative document platform may include content-creation templates for use in the collaborative document platform. Other types of software platforms that may use platform-specific content-creation templates as described herein may include codebase management systems, software development systems, project management systems, and the like. In order to provide template recommendations that are tailored for a particular user's interests, it may be advantageous to first identify a platform intent that indicates a user's preference for a particular software platform associated with the content collaboration service. Similar to the selection of a ranking engine based on the user class, a user's platform intent may be determined by employing different platform intent engines that are tailored to identify a user's platform intent using different types of datasets. By first identifying a particular software platform that is relevant to the user's interests, the selection and ranking of content-creation templates may be improved by initially narrowing the set of candidate content-creation templates to those that are likely to be of particular interest to the user. More particularly, if the user's platform intent is determined to relate to a collaborative document platform, the set of candidate content-creation templates from which recommendations are selected may be limited to templates from the collaborative document platform.

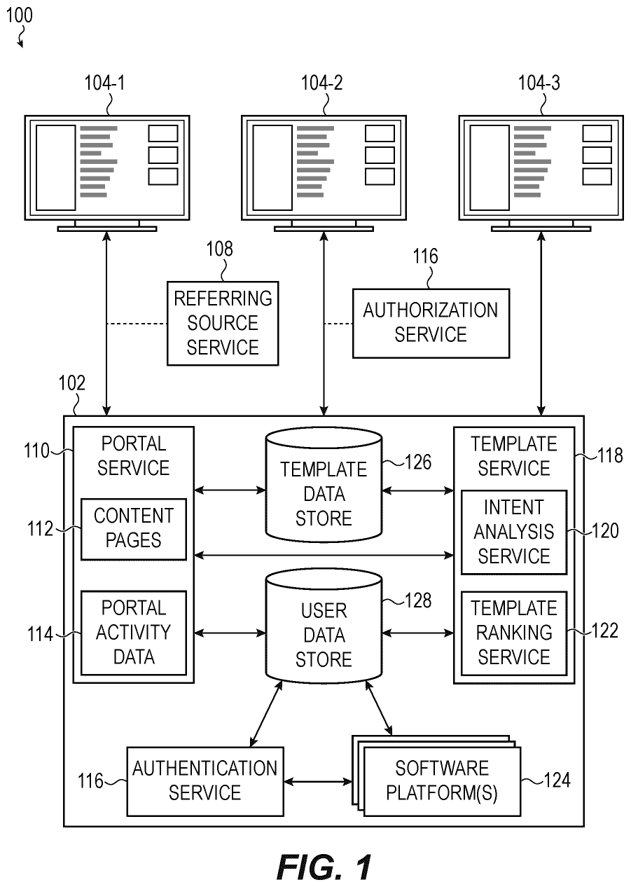

FIG. 1 depicts an example system 100 in which the techniques described herein may be employed. The system 100 includes a content collaboration service (CCS) 102, referring source services 108, and client devices 104 (104-1, 104-2, 104-3) that communicate via one or more networks (e.g., the Internet). The client devices 104 may be any suitable type of devices, including but not limited to a desktop or laptop computer, tablet computer, mobile phone, personal digital assistant, smart device, voice-based digital assistant, or the like. The client devices illustrated are merely for illustration, and more or fewer client devices may access the CCS 102. The client devices 104 may each represent a client associated with a different class of user, as described herein. Thus, for example, the first client device 104-1 may be associated with a user of a first user class (e.g., associated with semantic content from a referring source), the second client device 104-2 may be associated with a user of a second user class (e.g., associated with an account of the CCS 102and not associated with semantic content from a referring source), and the third client device 104-3 may be associated with a user of a third user class (e.g., not associated with an account or semantic content from a referring source).

The CCS 102 may be or may include one or more servers, content stores (e.g., databases), communications systems, data structures, programs, or other components, systems, or subsystems that provide content-item creation and storage services, content-creation template creation and storage services, user profile and workspace management services, and/or other services described herein. For example, the CCS 102 may include and/or provide a portal service 110, an authentication service 116, a template service 118, software platforms 124, a template data store 126, and a user data store 128. These components may execute over one or more computing resources of the CCS 102, and may share resources such as storage media, processors, memory, and the like. In some cases, they may be instantiated as separate computer systems (e.g., servers, databases, etc.) that communicate with one another to provide the functionality of the CCS 102.

The portal service 110 may provide services for instantiating a portal of the CCS 102. The portal may be or may include a user interface associated with the CCS 102, and may provide various types of information, services, data access, and the like to users of the portal. A portal instantiated, served, or otherwise provided by the portal service 110 may take the form of a website, a web browser-based application, a native client application, or any other suitable interface with which users can view, interact with, or otherwise access data, information, or services on the portal (e.g., portal pages, templates, software platforms, etc.). The portal service 110 may be associated with or accessed at a domain.

The portal service 110 may include portal pages 112 and portal activity data 114. The portal pages 112 may correspond to web pages of a website. The portal pages 112 may include various types of information, content, data, services, and the like. The portal pages 112 may include portal pages that are related to software platforms of the CCS 102. For example, the portal pages 112 may include portal pages related to an issue tracking software platform, a collaborative document software platform, a codebase management software platform, a software development software platform, and the like. The portal pages may include information about the software platforms and/or their capabilities. The portal pages may also include information about content-creation templates, as well as options to view or use content-creation templates. For example, a portal page of the portal service 110 may be configured to provide information about content-creation templates, and may provide selectable elements that allow a user to select a content-creation template. Selecting a content-creation template may cause a portal page that includes information about the selected template to be displayed to the user, and/or may cause a user interface to be displayed, where the user interface includes the selected template or is otherwise configured in accordance with the template definition. For example, and as described in greater detail herein, a user may select a selectable element associated with a marketing plan template. In response, a portal page with information about the template (and optionally a link or selectable element to access the template) may be displayed. As another option (e.g., if a user class criterion is satisfied), a user interface of a target software platform in which the content-creation template is used may be displayed (instead of a portal page), in which a content-creation interface that includes the content-creation template is displayed. In such cases, the content-creation interface of the target software platform may display a new content item that is pre-populated with the content-creation template (and/or information from the content-creation template). The new content item may then be saved (e.g., after user modification of the content item based on the content-creation template) and stored in association with the target software platform. For example, the new content item may be saved in a data store associated with the target software platform and incorporated into a content item hierarchy or other structure.

The portal activity data 114 may include portal activity data of users or visitors of the portal service 110. The portal activity data 114 may store information in association with a user identifier, which is associated with a unique user and/or a unique user interaction session with the portal. Thus, portal activity data 114 may be recorded in respect of a user's interaction session with the portal. Portal activity data 114 may include information such as a history of the sites (e.g., portal pages of the portal) visited by the user during the user interaction session, durations of portal page views, cursor information (e.g., clicks, cursor location, cursor dwell times, etc.), and the like. As described herein, portal activity data 114 may be used as factors for recommending content-creation templates. For example, if a user spends comparatively more time on pages devoted to marketing plans (and/or hovering a cursor over text related to marketing plans), this information may be captured and stored in the portal activity data 114, and a template service may use this information to determine the most relevant content-creation templates to recommend to the user.

The template service 118 may be configured to store template identifiers, retrieve templates (e.g., data files that correspond to content-creation templates) from the template data store 126, provide templates to the software platforms of the CCS 102, and provide template recommendations for inclusion in a portal page of a portal, among other possible template-related services. (The template service 118 may also or instead store links, addresses, or other identifiers of the content-creation templates, and may use such links, addresses, or other identifiers to provide the template services described herein.) The template service 118 may include an intent analysis service 120 and a template ranking service 122. The intent analysis service 120 may be configured to determine a platform intent of a user accessing a portal of the CCS 102. For example, the intent analysis service 120 may use a dataset associated with a user to determine a user preference for a software platform of a set of software platforms associated with the CCS 102. As described herein, the intent analysis service 120 may select different intent analysis engines based on the user class (and/or the type of available dataset) of the user for which the platform intent is being determined. The intent analysis service 120 may include and/or employ one or more machine learning and/or predictive models that are able to identify a platform intent based on a particular type of available dataset for a user.

The template service 118 also includes a template ranking service 122. The template ranking service 122 is configured to identify and rank content-creation templates based on their predicted relevance to a particular user of the portal. As described herein, the template ranking service 122 may select different template ranking engines based on the user class (and/or the type of available dataset) of the user for which the platform intent is being determined. The template ranking service 122 may include and/or employ one or more machine learning models that are able to identify and/or rank content-creation templates based on a particular type of available dataset for a user.

The CCS 102 includes a user data store 128. The user data store 128 may store and maintain user profiles about users of the CCS 102. User profiles may include numerous types of information (also referred to as attributes) about the users, including but not limited to content-creation template usage history, content item creation and access history, software platform usage history, names, departments, job titles, roles, teams with which they are associated, projects with which they are associated, supervisors, subordinates, team members, technical or occupational expertise, and relative position in a hierarchy in an organization or entity. The user data store 128 may communicate with or otherwise operate in conjunction with the portal service 110, template service 118, authentication service 116, software platforms 124, and/or other modules or services, to define and maintain associations between users and content items, content-creation templates, software platforms, or the like.

The user data store 128 may store various types of data associated with users of the CCS 102. In some cases, different types or categories of data may be stored in conjunction with different data security or protection controls. Thus, for example, data that may be considered personally identifiable information (e.g., names, addresses, identification numbers, date of birth, etc.) may be stored in secure locations, encrypted, or otherwise handled according to appropriate data security operations. As another example, login information such as credentials, passwords, usernames, and the like may be stored in secure locations, encrypted, hashed, or otherwise handled according to appropriate data security operations. In some cases, the user data store 128 may include multiple different databases, storage locations, storage media, data storage and security paradigms, and the like, and may store different classes or categories of data differently, depending on the particular data storage requirements or preferences for each class or category of data.

The authentication service 116 may be configured to authenticate users with respect to a user account with the CCS 102 and/or a software platform associated with the CCS 102. The authentication service 116 may receive credentials from a user (e.g., username and password, biometric information, or the like). The authentication service 116 may locate the credentials in the user data store 128 and perform an authentication operation (e.g., comparing a hashed password input to a stored password hash). If the authentication operation is successful, the user may be authenticated with respect to the CCS 102 and/or a software platform. When a user is authenticated by the authentication service 116, an authenticated session may be created for the user. The authenticated session may allow the user to access certain functionalities and services of the CCS 102 and/or a given software platform, such as functionalities and services that are restricted to authenticated users. In some cases, authenticated users of a software platform may be permitted to access and use the software platform, while non-authenticated users may not be permitted to access or use the software platform, or may only be able to access the software platform for a limited time or with limited functionality.

The template data store 126 stores content-creation templates for use in the CCS 102. The template service 118 (and more partially the template ranking service 122) may retrieve content-creation templates from the template data store 126 and provide the content-creation templates to software platforms 124, the portal service 110, or other services of the CCS 102. The content-creation templates may be data structures that include predefined content, formatting, organization, or other properties, parameters, or content of a content item that may be created and/or stored by the CCS 102 (and/or the software platforms of the CCS 102). For example, when a content-creation template is used, a content item may be pre-populated with content, formatting, etc., from the content-creation template, which a user may then use, modify, customize, or otherwise manipulate to form a user-generated content item. Content-creation templates may include or be associated with titles, descriptions, metadata, template content, template definitions, graphical objects, and the like. As described herein, the template service 118 may use any information or data of or associated with the content-creation templates in order to determine which content-creation templates to recommend to a user. For example, as described herein, a template ranking engine may use one or more models or algorithms that use input data (e.g., usage data, semantic data from a referring source, portal activity data, etc.) to identify relevant content-creation templates based on the content-creation template data (e.g., titles, descriptions, metadata, template contents, template definitions, and graphical objects).

The software platforms 124 include software platforms provided by the CCS 102. The software platforms 124 may use content-creation templates, as described herein. The software platforms 124 may include, for example, collaborative document platforms, issue tracking platforms, codebase management platforms, software development platforms, project management platforms, and the like. The software platforms 124 may include or be associated with a frontend that facilitates user interaction and provides the functionality of the platform. A frontend of a software platform, also referred to as a frontend or client application, may be configured to render a graphical user interface at a client device (e.g., the client devices 104) that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

While the template data store 126 and the user data store 128 are shown separate from the software platform(s) 124, it will be understood that they may be part of the software platform(s) 124. For example, content-creation templates may be stored in association with the particular software platform for which the content-creation templates are configured. More particularly, content-creation templates for use with a first software platform (e.g., a collaborative document platform) may be stored in association with the first software platform, while content-creation templates for use with a second software platform (e.g., an issue tracking platform) may be stored in association with the second software platform, and so forth. Similarly, user profiles may be stored in association with the particular software platform to which the user profiles relate. More particularly, user profiles for users of a first software platform (e.g., a collaborative document platform) may be stored in association with the first software platform, while user profiles of a second software platform (e.g., an issue tracking platform) may be stored in association with the second software platform, and so forth.

In some cases, a content store may store content items related to the CCS 102 and/or the software platforms 124. The content store may include content items of numerous types, including but not limited to text documents, spreadsheets, reports, production timelines, presentations, data files, issue records, issue tickets, portal pages (e.g., web pages, personalized landing pages), blogs, comment forums (including comments and/or other comment data), data objects, computer code (e.g., source code files, compiled code and/or applications, libraries, etc.), emails, media content (e.g., images, videos, etc.), and the like.

As noted above, the client devices 104 may each represent a client associated with a different class of user. For example, the first client device 104-1 may be associated with a user who is associated with semantic content from a referring source 108 (e.g., a website, a search engine, a software application, an advertisement, etc.). As such, a user identifier of the user of the first client device 104-1 may be assigned to the first user class. The second client device 104-2 may be associated with a user who is associated with a user account of the CCS 102 (e.g., as determined by the authentication service 116), but is not associated with semantic content from a referring source 108. As such, a user identifier of the user of the second client device 104-2 may be assigned to the second user class. The third client device 104-3 may be associated with a user who is not associated with a user account of the CCS 102 or with semantic content from a referring source. As such, a user identifier of the user of the third client device 104-3 may be assigned to the third user class.

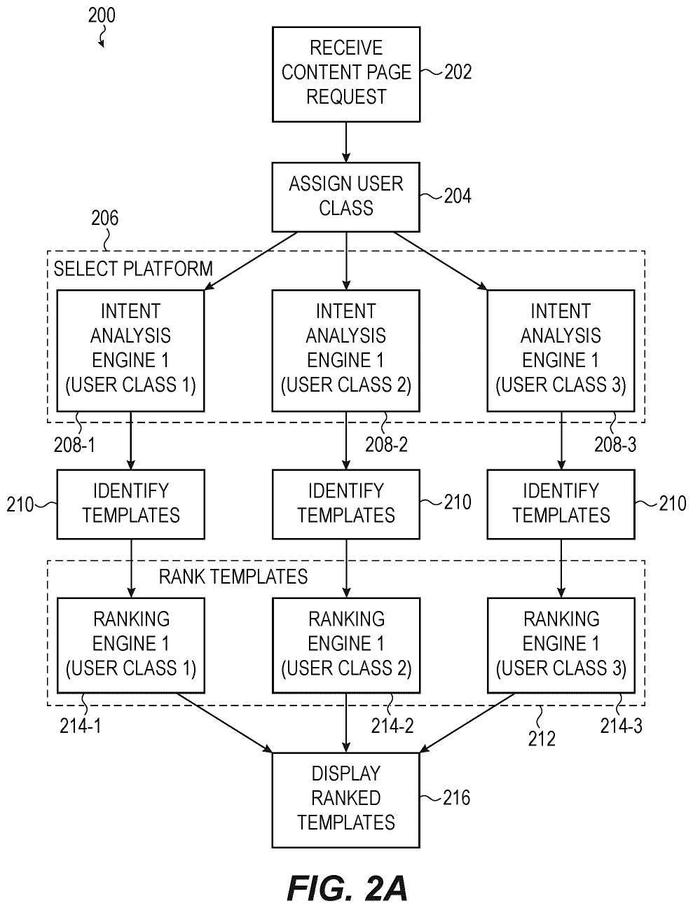

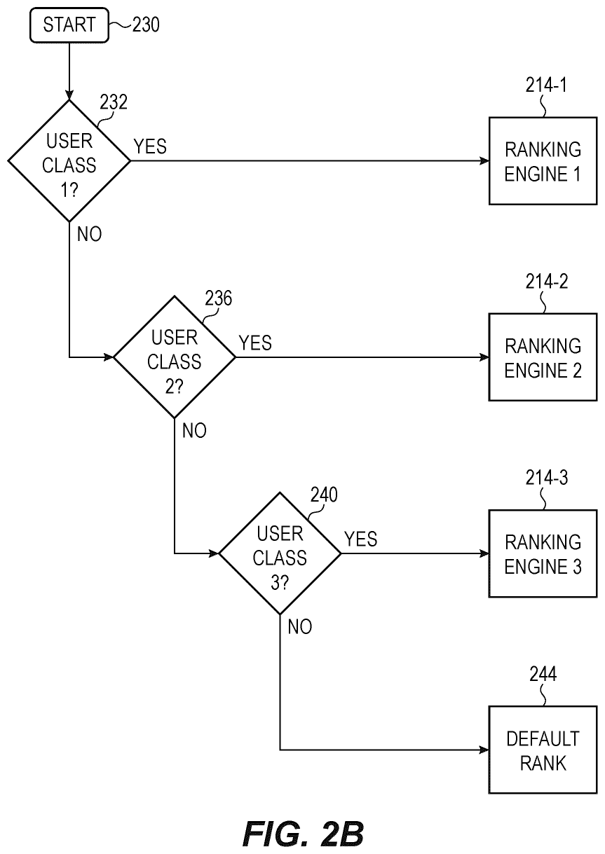

FIG. 2A illustrates an example process 200 for determining which content-creation templates of a set of available content-creation templates to recommend to a user. The operations described with respect to the process 200 may be performed by various services of the CCS 102, such as the portal service 110, the template service 118, the authentication service 116, and/or the software platforms 124.

As described herein, the process 200 may perform operations of determining a platform intent for the users, where the platform intent indicates a preference for a software platform of a set of software platforms associated with the content collaboration service. The process 200 may also identify and rank a set of candidate content-creation templates, and cause identifiers of and/or information about the candidate content-creation templates to be displayed to a user on a portal page according to the ranking. The process 200 may be performed by the CCS 102.

At operation 202, a portal page request may be received from a user. The portal page request may be configured to cause a portal page of the portal to be displayed to the user (e.g., on a client device). The portal page may be configured to display a set of identifiers of and/or information about recommended content-creation templates to the user, as described herein. The portal page request may be received by the portal service 110, which may serve the page to the user (e.g., to a client device of a user). In some cases, the portal page request may be received as part of a user interaction session with the portal, and optionally after the user has accessed other content in the portal, such as other portal pages (including portal pages that do not include template recommendations and/or portal pages that do include template recommendations). Accordingly, the portal page request may be received after a user has generated (and the portal service 110 has stored) portal activity data of the user during the user interaction session with the portal.

A portal page request may originate in various ways. For example, a portal page request may result from a user selecting a link to the portal page from another portal page of the portal. As another example, a portal page request may result from a user selecting a link in a portal page that is not served by the portal service, such as a search result in an internet search engine, or an advertisement or link on another website not served by the portal service. In some cases, affiliates or partners of the CCS 102 may promote or otherwise provide links to the portal and/or its portal pages. User selection of such links may result in the portal page request being received by the CCS 102.

In some cases, the portal page request includes semantic information about and/or from a referring source. The semantic information may provide information from which a user's platform intent and overall template interest may be determined. For example, a referring source may provide (e.g., to the portal service 110) search query terms that were input by the user to the referring source. As a particular example, the user may provide search query terms to a search engine, and the search engine (or a browser or other interface associated with the search engine) may provide the search query terms to the portal service 110. As another example, a referring source may provide other types of semantic information, such as text content that was displayed to the user by the referring source (e.g., text of web pages, advertisements, blog posts, articles, and the like). Other semantic information may include a user's site visit or page view history at the referring source (e.g., a page view history at a domain of the referring source). Other types or sources of semantic information may also be provided by the referring source.

In some cases, the portal page request is or is associated with an HTTP GET or HTTP POST request. In such cases, the semantic information may be included in the HTTP GET or POST request, such as in a referrer URL field. In some cases, a referring source provides the semantic information to the portal service via another communication path.

In some cases, in response to a portal page request, the CCS 102 (e.g., with the portal service 110 and/or the template service 118) may determine whether the referring source is a registered referring source with the CCS 102. For example, the portal service 110 and/or the template service 118 may consult a registry or database of approved or registered referring sources. If the referring source is a registered referring source, the portal service 110 and/or the template service 118 may accept the semantic information from the referring source. If the referring source is not a registered referring source, the portal service 110 and/or the template service 118 may reject the semantic information (and may rely on other information in order to generate content-creation template recommendations). In some cases, whether the referring source is a registered referring source affects the classification of a visiting user, as described herein.

In some cases, semantic content from registered referring sources is stored by the CCS 102. For example, a registry of referring sources may include or be associated with semantic content related to the referring sources. Thus, for example, if a portal page request is associated with a registered referring source, the CCS 102 may retrieve stored semantic content that is associated with that source. Such semantic content may include, without limitation, a source name, a source description, text that is displayed to users at the source, a summary of the content of the source, keywords or other information that relates to the content of the source (e.g., names of software platforms to which the source relates, names or descriptors of content items or types of content items to which the source relates, names or descriptors of content-creation templates to which the source relates), and the like.

At operation 204, a user identifier associated with the user requesting the portal page may be assigned to a user class. The user class may be selected from a set of user classes. The set of user classes may include a first user class indicating that the portal page request includes semantic content from the referring source. In some cases, the user identifier may be assigned to the first user class only if the semantic content is from a referring source registered with the content collaboration service, as described herein. (Otherwise, the user identifier may be assigned to the second user class or third user class, as described herein). As noted above, when a user is directed to the portal via a search engine or other website, the portal may receive an HTTP GET or POST request that includes a referrer URL with semantic content, resulting in the user identifier being assigned to the first user class. Other techniques for receiving or otherwise acquiring semantic content from a referring source are also described herein (e.g., consulting a registry that associates referral sources with predefined semantic content).

The set of user classes may also include a second user class indicating that the portal page request does not include semantic content from the referring source and that the user is associated with a user account of the content collaboration service. In some cases, a prerequisite to assigning a user identifier to the second user class (and the third user class) is that the portal page request does not include semantic content from the referring source. Thus, in some cases, any user associated with a portal page request that includes semantic content may be associate with the first user class, regardless of whether the user is associated with a user account of the CCS 102. The CCS 102 may determine whether the user is associated with a user account in various ways. For example, in some cases, at the time the portal page request is received from the user, the user may be associated with an authenticated session with the portal service 110 (e.g., based on an authentication of the user by the authentication service 116). In some cases, the CCS 102 (e.g., the portal service and/or the template service 118) may determine that the user is associated with a user account (and therefore assign the user identifier to the second user class) even if the user is not logged in or otherwise operating an authenticated session. For example, the CCS 102 may determine, based on an identifier of the user that is provided as part of the portal page request or otherwise accessible by the CCS 102, that the user is associated with a user account of the CCS 102. As described herein, user accounts of the CCS 102 may be unique to particular software platforms of the CCS 102. Thus, for example, a user may be associated with a user account of one software platform of the CCS 102 but not other software platforms of the CCS 102. As described herein, a user may be assigned to the second user class if the user is associated with a user account of any of the software platforms of the CCS 102. However, as described herein, the particular software platforms with which a user has an account (or subscription or other access permissions) may affect how a selected content-creation template is displayed to the user.

The set of user classes may also include a third user class indicating that the user is not associated with a user account of the content collaboration service and that the portal page request does not include semantic content from a referring source registered with the content collaboration service. For example, if a portal page request is associated with an HTTP GET or POST request that does not include a referrer URL or other semantic content (and the user is not associated with an account of the CCS 102), the user identifier may be assigned to the third user class. As another example, if a portal page request is associated with an HTTP GET or POST request that does include a referrer URL and/or semantic content from the referring source (and the user is not associated with an account of the CCS 102), but the referring source is not registered with the CCS 102, the user identifier may be assigned to the third user class.

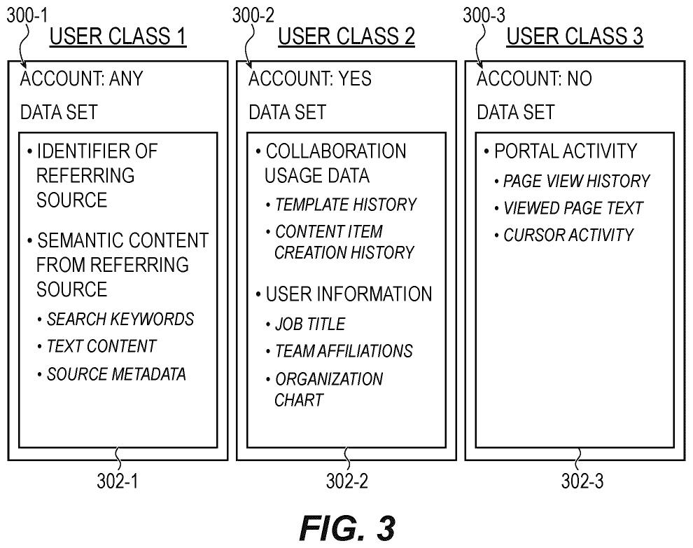

The assignment of a user identifier to a user class may generally correspond to a determination of a type of dataset that is available for the user. For example, if the available dataset for the user includes semantic content from a referring source, the user identifier may be assigned to the first user class. If the available dataset for the user does not include semantic content from the referring source and does include content collaboration service usage data associated with a user account of the content collaboration service (e.g., usage data associated with any software platform of the content collaboration service), the user identifier may be assigned to the second user class. If the available dataset for the user includes portal activity data of the user during a user interaction session with the portal of the content collaboration service and does not include semantic content from a referring source and does not include content collaboration service usage data associated with a user account of the content collaboration service, the user identifier may be assigned to the third user class. Example datasets of the user classes are further described herein with respect to FIG. 3.

Because each user class is associated with a different type of data from which the user's platform intent (and other preferences or interests) may be determined, different types of analysis engines may be used, for each user class, to determine what content-creation templates to present to the user.

At operation 206, a platform intent may be determined for a given user, where the platform intent indicates a preference for a particular software platform of a set of software platforms associated with the content collaboration service. Determining a platform intent may be used to identify a particular subset of content-creation templates from which template recommendations may be selected. For example, instead of selecting content-creation template recommendations from all content-creation templates that are available within the CCS 102, the template service 118 may initially filter or limit the pool of candidate content-creation templates to those that are associated with a particular software platform. This may help tailor the template recommendations to templates that the user is most likely interested in.

Platform intent may be determined differently for different user classes. More particularly, since each user class is associated with a different type of dataset, unique intent analysis engines may be selected for the different classes of user. For example, in accordance with a determination that the user identifier is assigned to the first user class, the platform intent may be determined using a first intent analysis engine 208-1, in accordance with a determination that the user identifier is assigned to the second user class, the platform intent may be determined using a second intent analysis engine 208-2, and in accordance with a determination that the user identifier is assigned to the third user class, the platform intent may be determined using a third intent analysis engine 208-3.

In accordance with a determination that the user identifier is assigned to the first user class, the platform intent may be determined using a first intent analysis engine 208-1. The first intent analysis engine 208-1 may be configured to determine the platform intent based at least in part on semantic content from the referring source.

The first intent analysis engine 208-1 may employ one or more predictive models that accept, as input, semantic content from the referring source, and provide, as output, an identification of a software platform that is likely to be of interest to the user based on the semantic content. The predictive models may include or rely on, without limitation, semantic similarity models, cosine similarity models, transformer-based models, term frequency-inverse document frequency models, and Siamese neural network models (and/or combinations of models).

The second intent analysis engine 208-2 may be configured to determine the platform intent based at least in part on content collaboration service usage data associated with the user account of the user.

The second intent analysis engine 208-2 may employ one or more predictive models that accept, as input, content collaboration service usage data, and provide, as output, an identification of a software platform that is likely to be of interest to the user based on the content collaboration service usage data. The predictive models may include or rely on, without limitation, hybrid matrix factorization models, tree-based models, neural collaborative filtering models, factorization models, gradient boosting models, logistic regression, and the like (and/or combinations of models).

In accordance with a determination that the user identifier is assigned to the third user class, the platform intent may be determined using a third intent analysis engine 208-3. The third intent analysis engine 208-3 may be configured to determine the platform intent based at least in part on portal activity data of the user during the user interaction session with the portal of the content collaboration service.

The third intent analysis engine 208-3 may employ one or more predictive models that accept, as input, portal activity data of the user during the user interaction session with the portal of the content collaboration service, and provide, as output, an identification of a software platform that is likely to be of interest to the user based on the portal activity data. The predictive models may include or rely on, without limitation, sequential recommendation models, recurrent neural network models, transformer models, and Markov chain models (and/or combinations of models).

In some cases, the output of the intent analysis engines is a confidence value or other score for each of the available software platforms. The software platform with the highest confidence value or score may be selected as the target software platform for which template recommendations may be generated.

Each of the intent analysis engines 208 may use information about the software platforms to train the models or otherwise provide the basis from which the platform intent is determined. Such information may include, without limitation, text descriptions of the software platforms (and/or its uses, functions, advantages, data types, content item types, etc.), content item information (e.g., titles, content, descriptions, etc. associated with the content items created in and/or stored in association with the software platforms), metadata, lists of registered users of the software platforms, and the like.

In some cases, each software platform is associated with a set of one or more keywords, and the intent analysis engines 208 may be trained on or otherwise use the keywords, and their association with particular software products, to determine a user's platform intent. For example, a collaborative document platform may be associated with keywords such as “teams” and “notes” and “create blog.” An issue tracking platform may be associated with keywords such as “help desk” and “issue tickets.” A software development platform may be associated with keywords such as “codebase” and “pipeline” and “repository.” These are merely example keywords, and other keywords may be associated with particular software platforms. Keywords may be identified and/or generated for the available software platforms using various techniques. For example, the CCS 102 may store a corpus of information from which associations between keywords and software platforms may be derived. The corpus may include descriptions of software platforms, content items created in and/or stored in association with the software platforms, user interaction histories with the software platforms, information about users who have used the software platforms (e.g., job titles, team affiliations, etc.), search queries that were associated with a user's accessing a software platform, and the like. The CCS 102 may analyze the corpus to associate particular keywords with particular software platforms. For example, the CCS 102 may use machine learning models to identify keywords and/or relevance scores for respective keywords for respective software platforms.

The keywords associated with the software platforms may be used by the intent analysis engines 208 to determine a platform intent of a user. For example, the first intent analysis engine 208-1 may determine a semantic similarity of the semantic content from the referring source (e.g., search query terms) to the keywords of the software platforms. The intent analysis service 120 may select the software platform that is associated with the highest match or relevance score between the semantic content and the keywords. Thus, if a user searches in a referring source for “software repository,” the intent analysis engine 208-1 may produce a relatively higher relevance score for the keyword “codebase” (associated with a software development platform) than for the keyword “issue tickets” (associated with an issue tracking platform). Using these relevance scores, the intent analysis engine 208-1 may identify that the user's platform intent relates to the software development platform. Similar approaches may be used by the other intent analysis engines to determine a platform intent. In particular, the intent analysis engines may be trained on or otherwise use the keywords, and their association(s) with the various software platforms, to determine respective confidence values or scores for the respective software platforms.

In some example implementations, the platform intent selection operation is not performed using intent analysis engines. For example, in some cases, a platform intent is provided by a user and/or as a result of a user interaction, such as when the portal page request corresponds to a request for a portal page that is explicitly related to a particular software platform. In this example, the template service 118 may filter the pool of candidate content-creation templates based on the portal page request (e.g., without the use of intent analysis engines). As another example, in some cases, a portal page request corresponds to a request for a portal page that includes templates for multiple different software platforms.

Based on the platform intent determined by the selected intent analysis engine 208, a software platform may be selected. For example, a software platform with a highest confidence score or ranking (as provided by the selected intent analysis engine) may be selected.

At operation 210, a set of candidate content-creation templates associated with the selected software platform may be identified. For example, each software platform may be associated with a set of content-creation templates that are usable in that software platform to create and/or modify content items. Identifying the set of candidate content-creation templates may include identifying the set of content-creation templates that are associated with the selected software platform. In examples where a software platform is not identified, such as in cases where no software platform meets a threshold confidence value, or in cases where the portal page is configured to display identifiers of and/or information about templates from multiple software platforms, the set of candidate content-creation templates may include content-creation templates associated with multiple software platforms (and optionally all content-creation templates used in the CCS 102).

At operation 212, the identified set of candidate content-creation templates are ranked based at least in part on the user class. Similar to the intent analysis engines, content-creation template rankings may be determined differently for different user classes. More particularly, since each user class is associated with a different type of dataset, unique ranking engines may be selected for the different classes of user in order to rank the content-creation templates. For example, in accordance with a determination that the user identifier is assigned to the first user class, the template ranking may be determined using a first ranking engine 214-1, in accordance with a determination that the user identifier is assigned to the second user class, the template ranking may be determined using a second ranking engine 214-2, and in accordance with a determination that the user identifier is assigned to the third user class, the template ranking may be determined using a third ranking engine 214-3.

In accordance with a determination that the user identifier is assigned to the first user class, the template ranking may be determined using a first ranking engine 214-1. The first ranking engine 214-1 may be configured to determine the template ranking based at least in part on semantic content from the referring source.

The first ranking engine 214-1 may employ one or more predictive models that accept, as input, semantic content from the referring source, and provide, as output, a ranking of the identified set of candidate content-creation templates. The predictive models may include or rely on, without limitation, semantic similarity models, cosine similarity models, transformer-based models, term frequency-inverse document frequency models, and Siamese neural network models (and/or combinations of models).

For example, the first ranking engine 214-1 may identify semantic content associated with respective content-creation templates, and determine semantic similarity scores between the semantic content from or associated with the referring source (including, for example, search query terms, text from the referring source, etc.) and the semantic content associated with the candidate content-creation templates (e.g., template text, template descriptions, template metadata, template usage history, etc.). The first ranking engine 214-1 may return a respective semantic similarity score for each of a subset of the candidate content-creation templates, and the candidate content-creation templates may be ranked based on the semantic similarity scores (and displayed to the user in accordance with the ranking).

The second ranking engine 214-2 may employ one or more predictive models that accept, as input, content collaboration service usage data, and provide, as output, a ranking of the identified set of candidate content-creation templates. The predictive models may include or rely on, without limitation, hybrid matrix factorization models, tree-based models, neural collaborative filtering models, factorization models, gradient boosting models, logistic regression, and the like (and/or combinations of models).

In accordance with a determination that the user identifier is assigned to the third user class, the template ranking may be determined using a third ranking engine 214-3. The third ranking engine 214-3 may be configured to determine the template ranking based at least in part on portal activity data of the user during the user interaction session with the portal of the content collaboration service.

The third ranking engine 214-3 may employ one or more predictive models that accept, as input, portal activity data of the user during the user interaction session with the portal of the content collaboration service, and provide, as output, a ranking of the identified set of candidate content-creation templates. The predictive models may include or rely on, without limitation, sequential recommendation models, recurrent neural network models, transformer models, and Markov chain models (and/or combinations of models).

Each of the ranking engines 214 may use information about the content-creation templates to train the models or otherwise provide the basis from which the template ranking is determined. Such information may include, without limitation, textual content of the content-creation templates, titles and descriptions of the content-creation templates, summaries of the content-creation templates, information about prior users of the content-creation templates (e.g., job titles of prior users, team affiliations of prior users, etc.), text or other content contained in content items that were initially generated using the content-creation templates, names of workspaces with which content items previously created using the content-creation templates are associated, metadata stored in association with the content-creation templates, and the like.

In some cases, the output of the template ranking engines 214 includes confidence values or scores (e.g., on a standardized scale, such as 0-1, 0-10, 0-100, or any other suitable scale) that represent the predicted relevance of that template to the input data (e.g., the dataset associated with the user). The template service 118 may cause identifiers of at least a portion of the set of candidate content-creation templates to be displayed on the portal page according to the ranking. Displaying the content-creation templates may include displaying information such as descriptions of the templates, links to the templates or links to further information about the templates, or the like. In some cases, the template service 118 may select a subset of the content-creation templates for display to the user, where the subset is the number of templates or template identifiers that the portal page is configured to display.

As described herein, content-creation templates that are displayed on the portal page may be selected by the user. A user selection of a content-creation template may be received by the CCS 102 (e.g., the portal service 110 and/or the template service 118) and may cause the CCS 102 to perform different actions depending on the class of the user. For example, in accordance with a determination that the user identifier is assigned to the second user class, the CCS 102 may cause a content-creation template interface to be displayed to the user in the selected software platform in an authenticated session. More particularly, the CCS 102 may cause a graphical user interface of the software platform of the selected content-creation template to be displayed to the user in a client device (e.g., in a web browser or other frontend application). Since the user identifier is associated with the second user class (e.g., the user is associated with a user account of the CCS 102), the CCS 102 may authenticate the user (optionally including prompting the user for and receiving login credentials) and instantiate an authenticated session of the software platform. The graphical user interface of the software platform may be pre-populated with the selected content-creation template, such that the user can immediately begin creating a content item using the content-creation template. In some cases, a content-creation template interface to be displayed to the user in the selected software platform in an authenticated session for a user of the first user class, if that user is associated with an account of the CCS 102. For example, if the user was assigned to the first user class due to the presence of semantic information from the referring source, but the user is also associated with an account of the CCS 102, then a user selection of a content-creation template may cause a graphical user interface of the software platform of the selected content-creation template to be displayed to the user in a client device (e.g., in a web browser or other frontend application).

The CCS 102 may perform different actions in response to a user selection of a template when the user identifier is assigned to the third user class or is otherwise not associated with an account of the CCS 102 (e.g., if the user identifier was assigned to the first user class due to the presence of semantic information from the referring source, but the user is not associated with an account of the CCS 102). For example, in accordance with a determination that the user identifier is assigned to the third user class or is otherwise not associated with an account of the CCS 102, the portal service 110 may cause an account registration interface to be displayed, in which the user can register for an account (e.g., a trial account or a full account) for the software platform. This result may reflect the fact that such users were not able to be associated with an existing user account. Accordingly, the user is offered an opportunity to register for an account. In response to a user registering for an account (e.g., a user of the first or third user class, or a user who is otherwise not associated with an account), the graphical user interface of the software platform may be displayed and may be pre-populated with the selected content-creation template, such that the user can immediately begin creating a content item using the content-creation template.

In some cases, in response to receiving a selection of a content-creation template (and optionally before displaying a user interface of a software platform or an account registration interface), the portal service 110 may cause the client to display a template information page that includes information about the selected template, such as a summary of the template, an example of a content item that includes the template, template options, and the like. The template information page may also allow the user to interact with a sample content item that includes the selected template (e.g., in a sandboxed environment). In some cases, the template information page provides a selectable element that a user can select to use the template directly in a software platform user interface, or to register for an account so that they can access the template in the software platform user interface.

In some cases, a user that is initially assigned to the third user class (or a user that is otherwise not associated with an account of the CCS 102) may log into or otherwise be authenticated by the CCS 102, which may change the manner in which content-creation template recommendations are provided to that user. For example, in response to authenticating a user, who was previously assigned to the third user class, with respect to the content collaboration service, the template service 118 may reassign the user identifier to the second user class, re-rank the set of candidate content-creation templates based at least in part on the content collaboration service usage data associated with the user account of the user (e.g., using the ranking engine 214-2 in FIG. 2A), and cause identifiers of at least a portion of the reranked set of candidate content-creation templates to be displayed on the portal page according to the reranking. In this way, the template service may provide more salient recommendations upon determining that a different dataset is available for the user.

Operations 204, 206, 210, and 212 of the process shown and described with respect to FIG. 2A may be performed by any combination of the systems or services of the CCS 102. For example, in some cases, operations 204, 206, 210, and 212 are performed by the template service 118, optionally in conjunction with the portal service 110, the authentication service 116, and the software platforms 124 (as well as the template data store 126 and the user data store 128). In some cases, operations 202 and 216 are performed by the portal service 110. More generally, the operations of the process 200 may be performed by any one of or any combination of the services of the CCS 102.

FIG. 2B illustrates a flow chart of an example technique for selecting a template ranking engine based on the user class and/or available dataset for a user. While FIG. 2B illustrates the flow chart in order to select template ranking engines, the same or similar flow chart and/or logic may be used to select intent analysis engines as well. The technique begins at 230, in response to a content page request (and/or in response to a set of templates being identified for a particular software platform). At operation 232, if the user is associated with the first user class (232, yes), the first ranking engine 214-1 is selected. As described herein, the user may be associated with the first user class if the content page request (or the user more generally) is associated with semantic content from a referring source. If the user is not associated with the first user class (232, no, corresponding to a determination that the user is not associated with semantic content from the referring source), it is determined at 236 whether the user is associated with the second user class. As described herein, the user may be associated with the second user class if the user is associated with a user account of the CCS 102 and not associated with semantic convent from the referring source. If the user is associated with the second user class (236, yes), the second ranking engine 214-2 is selected. If the user is not associated with the second user class (236, no), it is determined at 240 whether the user is associated with the third user class. As described herein, the user may be associated with the third user class if the user is not associated with a user account of the CCS 102 and not associated with semantic convent from the referring source. If the user is associated with the third user class (240, yes), the third ranking engine 214-3 is selected. If the user is not associated with the third user class (240, no), a default ranking of content-creation templates may be used to select content-creation templates to recommend. For example, the default ranking may correspond to user ratings of the content-creation templates, a number of instances of use of the content-creation templates (which may be scaled by recency), an alphabetical ranking by title, or any other suitable ranking.

FIG. 3 illustrates example datasets and account statuses that may be associated with user classes and used to determine platform intent and template rankings, as described herein. In some cases, the availability of a particular dataset or type of dataset for a user, along with the account status of the user, may be used to assign the user identifier to a user class. As described herein, the particular user class of a user identifier (and/or the available dataset for the user) may determine how platform intents are identified and how template suggestions are determined for the user.

As shown in FIG. 3, a first user class (e.g., user class 1) represents users who are associated with a dataset 302-1 that includes semantic information from the referring source. A user may be assigned to the first user class regardless of the account status of the user (e.g., account status 300-1=any). As described herein, the semantic information from the referring source may include, without limitation, an identifier of the referring source, search query terms, text content that was displayed to the user by the referring source (e.g., text of web pages, advertisements, blog posts, articles, and the like), metadata relating to the referring source, a user's visit or page view history at the referring source (e.g., a page view history at a domain of the referring source, or the like).

A second user class (e.g., user class 2) represents users who are not associated with semantic information from a referring source, but who have accounts with the CCS 102 (e.g., account status 300-2=yes). Because the user is associated with an account with the CCS 102, the available dataset 302-2 for the user includes content collaboration service usage data associated with a user account of the user. Content collaboration service usage data may include, without limitation, content-creation template usage history, content item creation and access history, software platform usage history, and the like. The dataset 302-2 may also include other information about the user from the user data store 128 of the CCS 102, such as job titles, team affiliations, relative position in a hierarchy or organization chart in an organization or entity, roles or role descriptions, projects with which they are associated, supervisors, subordinates, team members, technical or occupational expertise, and the like. In some cases, other data is also available for users of a second user class, such as portal activity data of the user during a user interaction session with the portal.

A third user class (e.g., user class 3) represents users who do not have account with the CCS 102 (e.g., account status 300-3=no) (or who have an account but are not currently authenticated to the CCS 102), and are also not associated with semantic information from the referring source (or for which semantic information from the referring source is rejected). In such cases, the available dataset 302-3 may include portal activity data of the user during the user interaction session with the portal of the CCS 102. Portal activity data may include, without limitation, page view history in the portal (e.g., in an internet domain associated with the portal), text content of pages viewed on the portal, durations of portal page views, cursor information (e.g., clicks, cursor location, cursor dwell times, etc.), and the like.

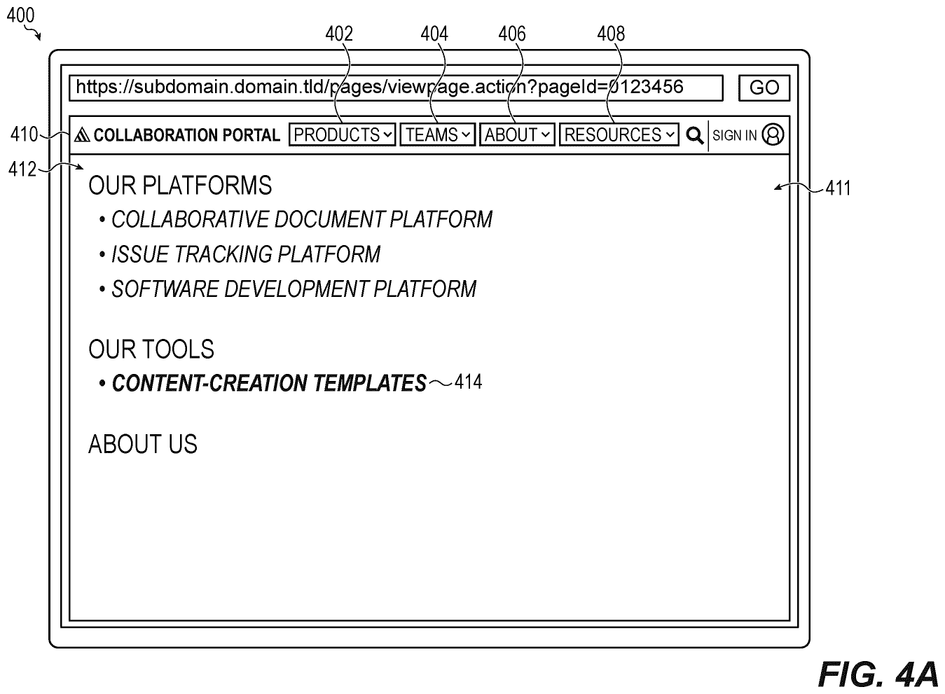

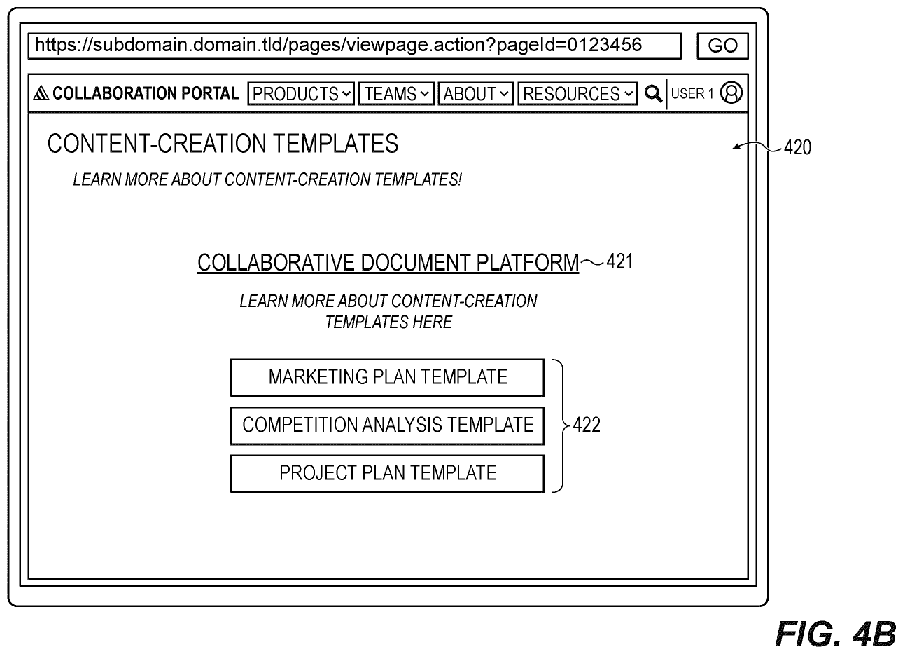

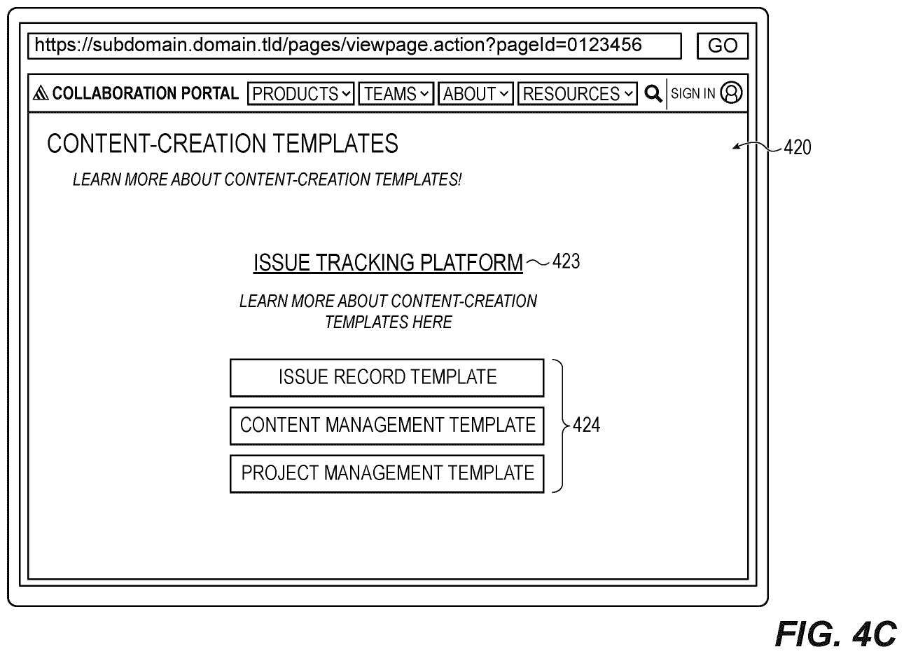

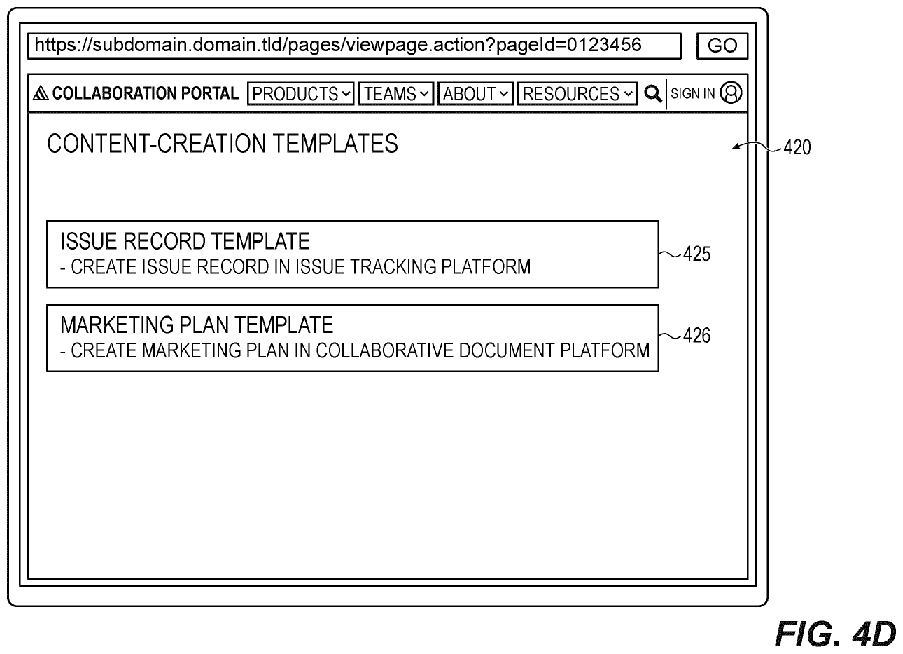

FIGS. 4A-6C illustrate example user interfaces that may be displayed to a user on a client device during an interaction session with a portal of the CCS 102 and/or with software platforms of the CCS 102. FIG. 4A, for example, illustrates a graphical user interface (GUI) 400. The GUI 400 may be rendered in a browser executing on a client device 104, while at least some processing tasks and other operations associated with the CCS 102 are performed by a remote server (e.g., a server of the CCS 102). In other cases, the graphical user interface 400 may be rendered by a native application executing on the client device 104. Regardless of architecture, it may be appreciated that generally and broadly a graphical user interface may be displayed on a client device and be operable to receive inputs from and provide outputs to a user of the CCS 102.

The GUI 400 may correspond to a portal page of the CCS 102. The GUI 400 may include selectable elements that provide access to other content on the portal. For example, an element 402 may cause the GUI 400 to display a listing of links to products, such as software platforms, provided by the CCS 102. An element 404 may cause the GUI 400 to display a listing of links to products or services that are categorized by the type of team or organization to which they apply. An element 406 may cause the GUI 400 to display information about the CCS 102, the portal service 110, or the like. An element 408 may cause the GUI 400 to display a listing of support resources, services, or other offerings provided by the CCS 102. It will be understood that these are merely exemplary, and more, fewer, or different selectable elements may be included in a GUI 400.

The GUI 400 also includes a content display region 410, where content of the portal may be displayed. The displayed portal content may correspond to one or more portal pages of the portal. In some cases, the portal pages are webpages of a domain. FIG. 4A illustrates the GUI 400 displaying a portal page 411 in the content display region 410. In this example, the portal page 411 includes selectable elements, taking the form in this example of text links relating to software platforms provided by the content collaboration service (e.g., “Collaborative Document Platform,” “Issue Tracking Platform,” and “Software Development Platform”), text links relating to tools offered by the content collaboration service (e.g., “Content-Creation Templates”), and the like. In response to a user selection of a selectable element, the portal may display another portal page (e.g., webpage) that is referenced by the selectable element. For example, in response to a selection of a selectable element 414 relating to the “Content-Creation Templates,” the portal may cause a portal page related to content-creation templates to be displayed. In such cases, as described herein, as a result of a user selection of the selectable element 414, a portal page request is sent to (and/or received by) the portal service 110, and the portal service 110 performs the operations described with respect to the process 200, including assigning a user class to the user who initiated the selection, determining a platform intent to select a software platform indicating a user preference of a particular software platform, and ranking content-creation templates associated with that platform using a ranking engine selected in accordance with the assigned user class.

In some cases, in response to a selection of a selectable element relating to a particular software platform, such as the “Collaborative Document Platform,” the portal may display a portal page with information that is related to a collaborative document software platform. In some cases, the portal page may include content-creation template recommendations, which are selected in accordance with the process 200, as described herein. In this example, the content collaboration service may omit the operations of determining a platform intent and selecting a software platform, since the user's selection of a particular software platform indicates a user preference for a particular software platform.

FIGS. 4B and 4C illustrate an example portal page that may be displayed in response to a user selection of a selectable element corresponding to a portal page related to content-creation templates. For example, the portal pages shown in FIGS. 4B-4C may be displayed in response to a user selection of the selectable element 414 in FIG. 4A. The user's selection of the element 414 may indicate the user's interest in content-creation templates generally, and without specifying a particular software platform of interest. As described above with respect to FIG. 2A, in response to a portal page request for a portal page that includes content-creation templates for multiple software platforms (e.g., a request that is not associated with a particular software platform), a template service 118 may identify a software platform and select content-creation templates for that platform based on a user class of the user (e.g., based on the type of dataset available for that user). Thus, a different set of content-creation templates may be displayed or presented to the user depending on the user class. FIGS. 4B and 4C illustrate examples of different sets of content-creation templates based on the different user classes. While FIGS. 4B and 4C illustrate a portal page 420 that includes identifiers of content-creation templates, it will be understood that the portal page 420 may include other information as well, such as general information about content-creation templates, options to register for an account, information about software platforms, and the like.

FIG. 4B illustrates the content of a portal page 420 that may be displayed in response to a user selection of the selectable element 414, where the user is associated with a one user class (e.g., a user for whom an available dataset includes a certain type of information), and FIG. 4C illustrates the portal page 420 where the selecting user is associated with another user class (e.g., a user for whom an available dataset includes a different type of information). It will be understood that in this discussion, the user classes may correspond to the first and second user classes described with respect to FIG. 2A, for example, or to any two user classes that are different from one another (e.g., are associated with different types of datasets).

As shown in FIG. 4B, the portal page 420 includes a set of identifiers 422 of content-creation templates relating to a software platform 421 (e.g., a collaborative document platform). The identifiers 422 of the content-creation templates (or any other identifiers of content-creation templates shown or described herein) may be selectable elements. In response to a user selection of one of the identifiers 422, the portal service 110 may perform one or more operations, such as displaying a template interface, displaying a separate portal page with information about the selected content-creation template, or the like. The particular operation that is performed may depend at least in part on the user class, as described herein.

In FIG. 4C, the portal page 420 includes a set of identifiers 424 of different content-creation templates relating to a software platform 423 (e.g., an issue tracking platform). As described herein, the particular selection of the software platform from which the content-creation templates are identified, and the particular order in which the content-creation templates are displayed, is determined based at least in part on the user class assigned to the user who requested the page. And as described herein, the user class may generally correspond to or reflect the type of dataset that is available for that user. Thus, for example, the version of the portal page 420 shown in FIG. 4B may be displayed in response to a determination that the selecting user is assigned to the second user class, such as a user who is associated with a user account of the content collaboration service but not semantic information from a referring source. As such, the selection of the Collaborative Document Platform and the particular content-creation templates shown in FIG. 4B may be determined using information associated with the user account (e.g., template usage history, software platform usage history, software platform licenses or accounts, content item access history, job titles, etc.). This data may be provided as input to a template ranking engine that is specifically configured to rank content-creation templates based on this type of data, and optionally to an intent analysis engine that is specifically configured to determine platform intents based on this type of data, as described with respect to FIG. 2A.

On the other hand, the version of the portal page 420 shown in FIG. 4C may be displayed in response to a determination that the selecting user is assigned to the third user class, such as a user who is not associated with a user account of the content collaboration service and who is not associated with semantic content from a referring source. As such, the selection of the Issue Tracking Platform and the particular content-creation templates shown in FIG. 4C may be determined using portal activity data of the user during the user interaction session with the portal of the content collaboration service. For example, prior to requesting the portal page 420, the user may have performed actions within the portal, such as selecting portal pages related to the issue tracking platform, hovering a cursor over content associated with the issue tracking platform, entering search terms into a portal search field with terms that relate to or are suggestive of the issue tracking platform. This data may be provided as input to a template ranking engine that is specifically configured to rank content-creation templates based on this type of data, and optionally to an intent analysis engine that is specifically configured to determine platform intents based on this type of data, as described with respect to FIG. 2A.

FIGS. 4B and 4C illustrate an example portal page 420 in which the displayed identifiers of the content-creation templates are each associated with a particular software platform. For example, FIG. 4B includes content-creation template identifiers 422 associated with the Collaborative Document Platform 421, and FIG. 4C includes content-creation template identifiers 424 associated with the Issue Tracking Platform 423. In some cases, in response to a request for the portal page 420, the template service 118 may select content-creation templates from multiple different software platforms and display them. This may occur, for example, where an intent analysis engine does not produce a platform intent that satisfies a threshold confidence value, or where the portal service 110 is otherwise configured to display identifiers of and/or information about content-creation templates from multiple different software platforms together. FIG. 4D illustrates an example of the portal page 420 that includes content-creation template identifiers that are associated with different software platforms. For example, the content-creation template identifier 425 may be associated with a template that operates in an issue tracking software platform, and the content-creation template identifier 426 may be associated with a template that operates in a content collaboration platform. The identifiers may include information specifying the function of the content-creation template, as well as the particular software platform in which the content-creation template is configured to operate.

As described herein, the particular content-creation template identifiers that are displayed may be based on the ranking of the candidate content-creation templates, as provided by a selected ranking engine. In some cases, identifiers of the n highest ranked content-creation templates are displayed (where n=1, n=2, n=3, or any other suitable value). In some cases, the identifiers are displayed in a scrollable or navigable list, in which the user can browse through the list of templates, optionally causing previously undisplayed template identifiers to be displayed on the portal page.

FIGS. 4B-4D depict content-creation template identifiers that include a textual title of the associated content-creation template. However, this is merely for illustration purposes, and the actual contents of the content-creation template identifiers may differ. For example, the identifiers may include other textual content, including descriptions of the content-creation template, images of the content-creation templates and/or of content items produced using the content-creation templates, graphics or icons associated with the content-creation templates, information about the software platforms associated with the content-creation templates, etc. Content-creation template identifiers may be associated with or presented as tiles, cells, text lists, or the like.

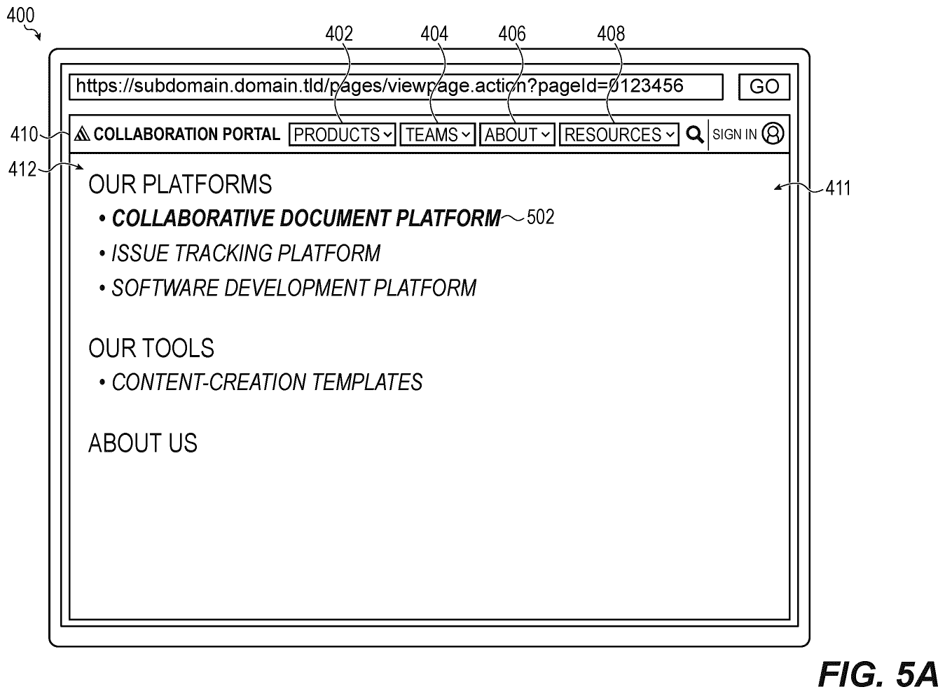

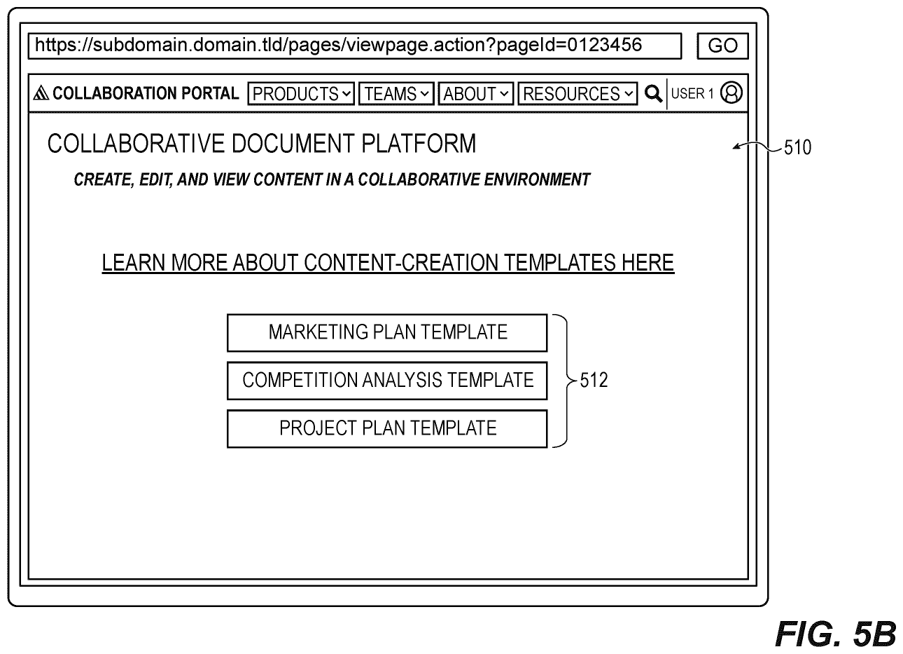

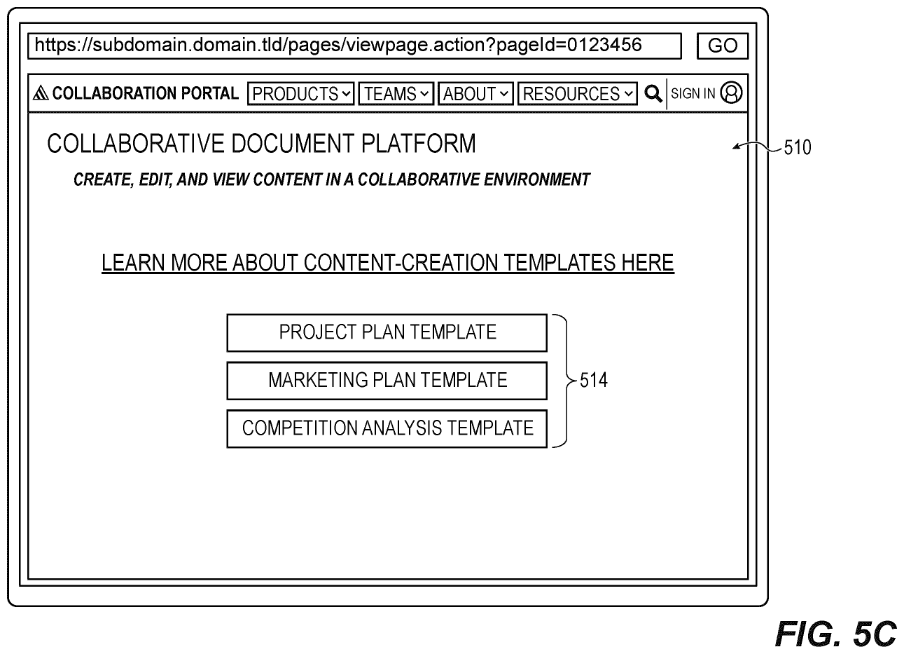

FIGS. 4B-4D depict a portal page that is related to content-creation templates generally, rather than a specific software platform. As such, as noted above, the content-creation template identifiers that are displayed may be selected based on an initial determination of the user's platform intent, such that the recommended content-creation templates are associated with a particular software platform of interest to the user. As described above, in some cases, a user may select a portal page that is specifically related to a particular software platform. In such cases, the operations for identifying a user's platform intent and selecting a software platform may be omitted, as the target software platform is specified by the user's selection. FIG. 5A illustrates the portal page 411, reflecting a user selection of a selectable element 502, which corresponds to a link to another portal page that includes information about a collaborative document platform. Since this selection includes an implicit platform intent, the template service 118 may omit operations directed to determining a platform intent and/or selecting a software platform based on the platform intent, and may proceed to selecting a ranking engine and ranking the templates for the selected software platform using the selected ranking engine.

FIGS. 5B and 5C illustrate an example portal page 510 that may be displayed in response to a user selection of a selectable element corresponding to a portal page related to a particular software platform. For example, the portal pages shown in FIGS. 5B-5C may be displayed in response to a user selection of the selectable element 502 in FIG. 5A. Whereas the selection of the element 414 in FIG. 4A did not specify a particular software platform of interest, the selected portal page in FIG. 5A is specifically related to a particular software platform.

As described above with respect to FIG. 2A, in response to a portal page request for a portal page that is related to a particular software platform, a template service 118 may identify a set of templates for the particular software platform of the selected portal page, select a ranking engine based at least in part on the user class (e.g., based on the type of dataset available for that user), and rank the content-creation templates using the ranking engine. In this example as well, a different set of content-creation templates (for the same software platform) may be displayed or presented to the user depending on the user's user class.

For example, FIG. 5B illustrates the content of a portal page 510 that may be displayed in response to a user selection of the selectable element 502, where the user is associated with one user class (e.g., a user for whom an available dataset includes a certain type of information), and FIG. 5C illustrates the portal page 510 where the selecting user is associated with another user class (e.g., a user for whom an available dataset includes a different type of information). It will be understood that in this discussion, the user classes may correspond to the first and second user classes described with respect to FIG. 2A, for example, or to any two user classes that are different from one another (e.g., are associated with different types of datasets).

As shown in FIG. 5B, the portal page 510 includes a set of identifiers 512 of content-creation templates relating to the software platform of the portal page 510. In FIG. 5C, the portal page 510 includes a set of identifiers 514 of content-creation templates relating to the same software platform. The sets of identifiers 512, 514 may differ in the particular content-creation templates that are included, and/or the ranking of the templates. As shown in FIGS. 5B-5C, both instances of the portal page 510 include the same content-creation templates, but in a different order, reflecting the different rankings of the content-creation templates for each user. It will be understood that there need not be any commonality between the particular content-creation templates that are selected for different users, as the selection is based on the content-creation template ranking for each individual user.

As described herein, the particular selection of the content-creation templates, and the particular order in which they are displayed, is determined based at least in part on the user class assigned to the user who requested the page. And as described herein, the user class may generally correspond to or reflect the type of dataset that is available for that user. Thus, for example, the version of the portal page 510 shown in FIG. 5B may be displayed in response to a determination that the selecting user is assigned to the second user class, such as a user who is associated with a user account of the content collaboration service but not semantic information from a referring source. As such, the selection of the particular content-creation templates shown in FIG. 5B (e.g., based on the ranking of the content-creation templates associated with the collaborative document platform) may be determined using information associated with the user account (e.g., template usage history, software platform usage history, software platform licenses or accounts, content item access history, job titles, etc.). This data may be provided as input to a template ranking engine that is specifically configured to rank content-creation templates based on this type of data, as described with respect to FIG. 2A.

On the other hand, the version of the portal page 510 shown in FIG. 5C may be displayed in response to a determination that the selecting user is assigned to the first user class, such as a user who is associated with semantic content from a referring source. As such, the selection of the particular content-creation templates shown in FIG. 5C (e.g., based on the ranking of the content-creation templates associated with the collaborative document platform) may be determined using the semantic content from the referring source. For example, a referring source from which the request for the portal page 411 (or the portal page 510) originated may include semantic content, such as user search keywords or terms, content from the referring source (e.g., from the referring webpage), content that is associated with the referring source but stored by the content collaboration service, or the like. The available semantic content may be provided as input to a template ranking engine that is specifically configured to rank content-creation templates based on this type of data, as described with respect to FIG. 2A. Since the portal pages in FIGS. 5B and 5C are associated with requests from users of different user classes (and thus different ranking engines and different user datasets), the particular content-creation template identifiers that are displayed in each instance may be different. For example, the ranking engine selected for the user in FIG. 5B may return (ranked highest to lowest) a marketing plan template, a competition analysis template, and a project plan template. The ranking engine selected for the user in FIG. 5C, on the other hand, may return (ranked highest to lowest), the project plan template, the marketing plan template, and the competition analysis template. The different order of the content-creation templates (and the selection of these content-creation templates from the set of candidate content-creation templates for the collaborative document platform more generally) is based on the output of the particular ranking engine that is selected and the user dataset that is provided to the ranking engine.

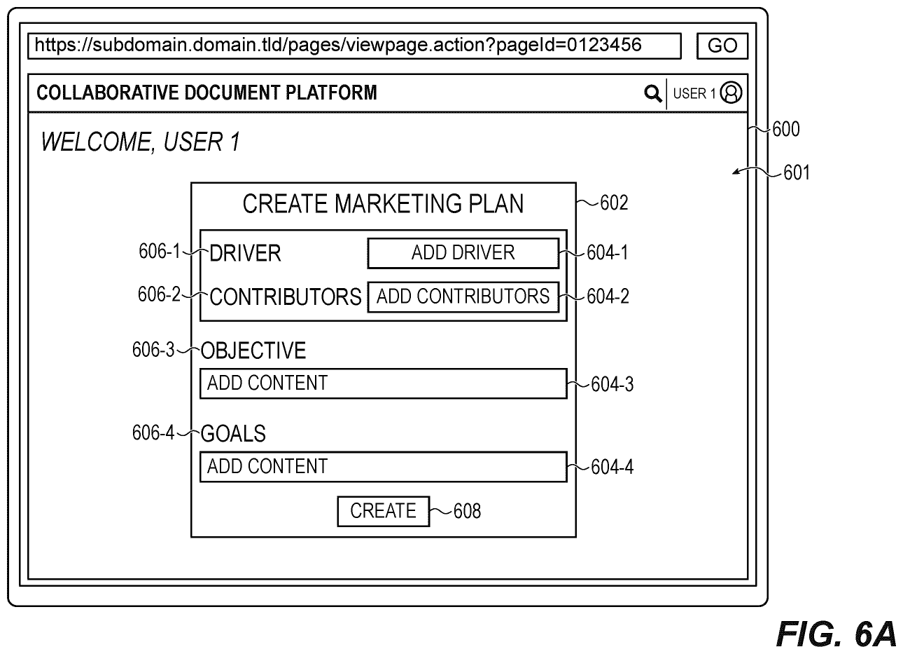

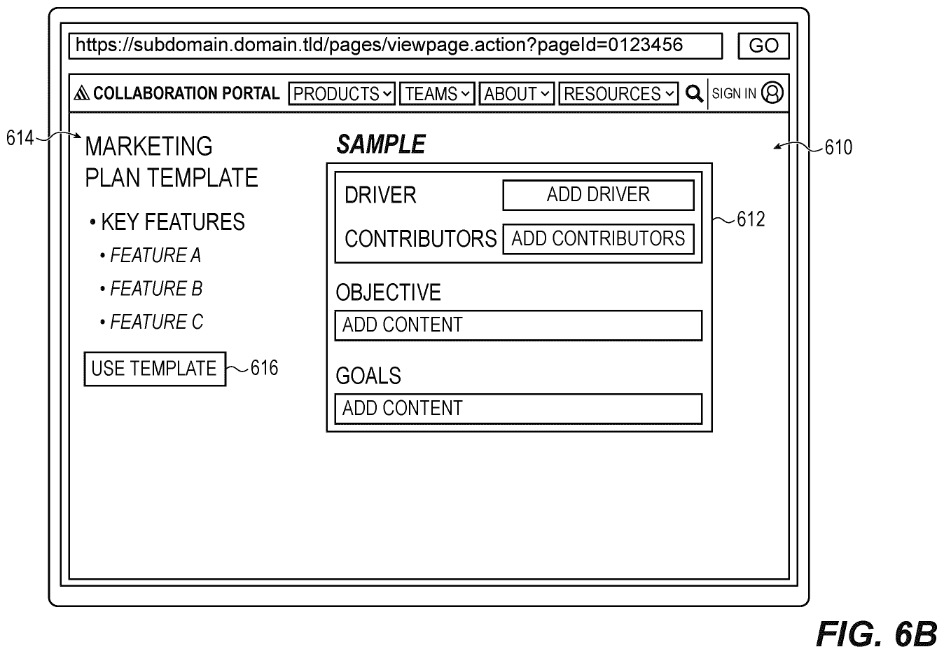

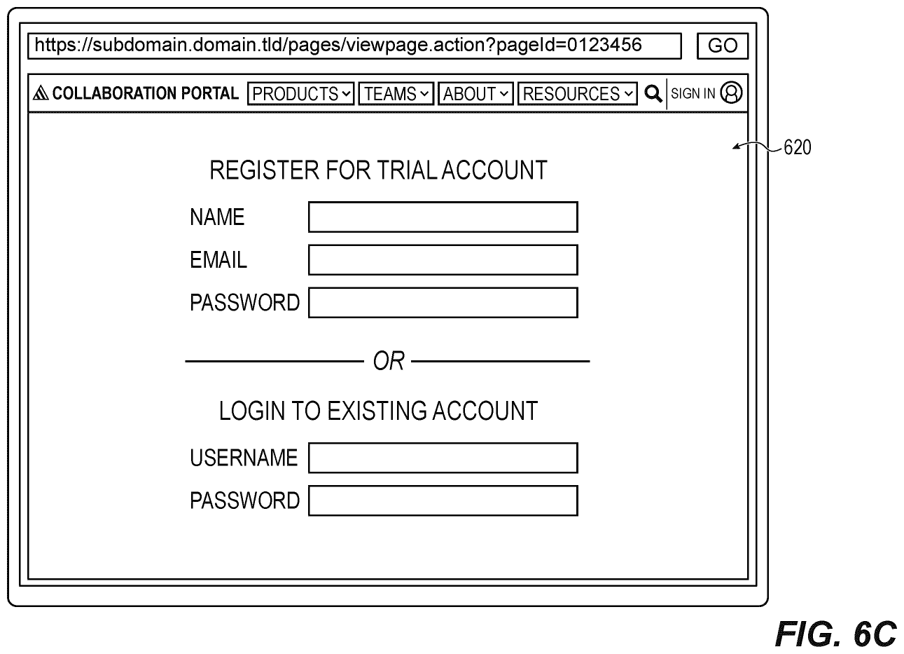

As noted above, the identifiers of the content-creation templates that are displayed to a user on a portal page may be selectable elements. In response to a user selection of one of the identifiers, the portal service 110 may present another portal page or user interface to the user, where the particular page or interface that is displayed is selected based on the content-creation template that was selected and the user's user class. For example, different content may be displayed to a user if that user is associated with a user account of the content collaboration service (or a software platform of the content collaboration service) than if the user is not associated with a user account. FIGS. 6A-6B illustrate example content that may be displayed in response to a user selection of an identifier of a template on a portal page (such as the portal pages in FIGS. 4B-4C and 5B-5C).

FIG. 6A illustrates a user interface 600 that may be displayed in response to a user selection of an identifier of a content-creation template, where the user is associated with a user account of the content collaboration service. More particularly, when a user is associated with a user account of the content collaboration service (or, more particularly, with a software platform of the selected content-creation template), the user may have authorization to access the software platform in which the content-creation template is operative. Accordingly, the user's selection of the content-creation template may result in a user interface of the associated software platform being displayed to the user, with a draft content item prepopulated with the selected content-creation template. The displayed user interface may be associated with an authenticated session for the user, such that the user can begin interacting with the content item and/or the content-creation template.

Returning to FIG. 6A, in response to a selection of an identifier of a content-creation template (e.g., a marketing plan template) by a user associated with a user account of the content collaboration service and/or a software platform associated with the content-creation template, a user interface 600 may be displayed. The user interface 600 corresponds to the particular software platform in which the content-creation template is operative (and for which the user has an account). For example, if the selected content-creation template is operative in a collaborative document platform, the user interface 600 may be a user interface of the collaborative document platform. Additionally, the user interface 600 may be associated with an authenticated session for the user. For example, in response to receiving the selection from the user, the portal service 110 may determine whether the user is currently associated with an authenticated session, or, if not, whether the user is associated with a user account. If the user is associated with a user account but not a current authenticated session, the portal service 110 may (with the authentication service 116) authenticate the user and establish an authenticated session for the software platform.

In some cases, users may be associated with accounts (or licenses or other permissions) for some but not all software platforms of a content collaboration service. Thus, in response to receiving a selection of a content-creation template, as described herein, the portal service 110 may determine whether the user has an account or license or is otherwise permitted to access the software platform associated with the selected software platform. If the user is permitted to access the software platform, the user interface with a content item pre-populated with the selected content-creation template may be displayed. If not, a different portal page (e.g., the page shown in FIG. 6B) may be displayed instead.

As shown in FIG. 6A, the user interface 600 includes a content-creation template 602 in a content display region 601. The content-creation template 602 may include various types of content, including textual content, text labels, graphical content, icons, text or other input fields, text or item chooser objects, menus, or the like. The content-creation template 602 may also have a particular appearance, layout, formatting, arrangement, and the like. The particular content, appearance, layout, formatting, arrangement, etc., of the content-creation template 602 may depend on the particular type of content item that it is configured to generate or to be created in. As described herein, content-creation templates may be provided for creating or being incorporated into documents, blog posts, issue records, codebases, comments, emails, spreadsheets, and the like.

As shown in FIG. 6A, the template 602 includes labels 606 and input fields 604. The labels 606 provide predetermined or pre-established textual or other content (which may be editable or non-editable by the user). The input fields 604 may accept user-generated content, which will ultimately be incorporated into the content item that is generated using the content-creation template. In this specific example, the content-creation template 602 corresponds to a template for a marketing plan and includes labels 606 and input fields 604 that are relevant to creating a marketing plan. The template 602 may also include a “create” element 608. In response to selecting the create element 608, the software platform 124 may generate and/or save a content item created in accordance with the content-creation template 602 (including any user-supplied information or content).

If the user who has selected an identifier of a content-creation template is not associated with a user account of the content collaboration service and/or a particular software platform of the content collaboration service (e.g., the platform of the selected content-creation template), the selection of the identifier may result in different content being presented to the user. More particularly, since the user is not associated with a user account of the software platform, the user may not have permission to access the software platform of the selected content-creation template. In such cases, the portal service 110 may cause a portal page to be displayed to the user, where the portal page includes information about the selected content-creation template and optionally the software platform in which the content-creation template operates.

FIG. 6B illustrates an example portal page 610 that may be displayed in response to a user selection of a content-creation template for a marketing plan, where the user selection was from a user who is not associated with a user account of the content collaboration service and/or a software platform associated with the content-creation template. Since the user is not associated with a user account, the portal page 610 may include information 614 about the template and a template preview 612. The template information 614 may include a summary of the template, example features, the type of content item that it is associated with, and/or other information. The template preview 612 may include one or more images of the template, one or more images of content items produced using the template, and the like.

The portal page 610 may also provide a selectable element 616 that a user can select if they wish to use the template. In response to selecting the element 616, the portal service 110 may cause display of an account registration interface 620, as shown in FIG. 6C. More particularly, since the user who was presented the portal page 610 is not associated with a user account (or at least had not authenticated themselves to the portal service 110), the user may not be able to access the user interface of the software platform to interact with the content-creation template without at least a trial account. Accordingly, the account registration interface 620 may allow the user to register for a trial (or optionally a fully subscribed account). In some cases, after registering for a trial account, the user is automatically presented with a user interface that includes the selected content-creation template, such as the user interface 600 in FIG. 6A. The portal page 610 may also include a login option for users that have existing user accounts, but for which their session with the portal service 110 was not authenticated or otherwise associated with their user account. In response to a user logging-in via the portal page 610 (and in particular, after arriving at the portal page 610 via a selection of a content-creation template), the user may be presented with the user interface 600, as shown in FIG. 6A.

In some cases, when a user who is not associated with a user account of a software platform selects an identifier of a content-creation template for that software platform, the user is first prompted to create an account, such as a trial account, (e.g., via the portal page 620). In such cases, the user may be presented with an option to decline the account. In response to a selection to decline the account, the portal service 110 may cause the portal page 610 to be displayed to provide more information about the content-creation template. If the user registers for a account, on the other hand, the portal service 110 may cause the user interface 600 to be displayed to the user. In some cases, different account registration or provisioning interfaces may be presented depending on whether the user has no account with the CCS (e.g., no account with any software platforms of the CCS), or whether the user has an account with different software platform of the CCS (e.g., if the user has an account with a software platform other than that which is associated with the selected software platform). For example, for a user who is already associated with a user account of a different software platform, certain provisioning or user account generation operations may be omitted. By contrast, a user who is not associated with any accounts of the CCS may be prompted for additional information or otherwise prompted to create an initial account with the CCS.

In some cases, when a user who is not associated with a user account selects an identifier of a content-creation template, a trial or sandboxed user interface may be presented to the user, allowing the user to interact with the content-creation template. In some cases, the content-creation template may be fully functional, except that no content item can ultimately be saved or created. In this way, the user can have the experience of creating a content item or otherwise interacting with the template, despite not being associated with an account or otherwise being a licensed user. In other examples, the content-creation template may be partially functional, in which certain functions and operations of the template and/or the content-creation interface more generally are available, and others are not. The trial or sandboxed user interface may appear the same as or similar to the user interface 600 in FIG. 6A.

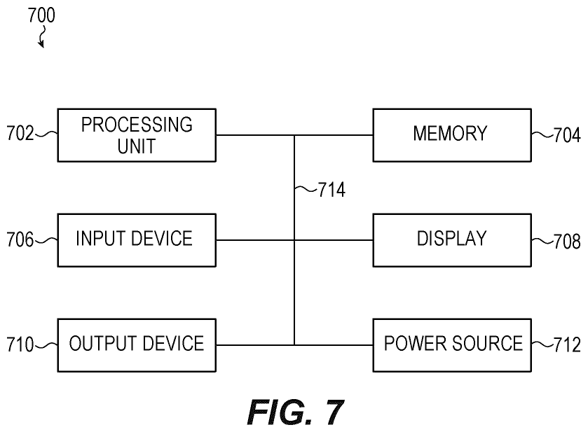

FIG. 7 shows a sample electrical block diagram of an electronic device 700 that may perform the operations described herein. The electronic device 700 may in some cases take the form of any of the electronic devices described with reference to FIGS. 1-6C, including client devices, and/or servers or other computing devices associated with the content collaboration service 102. The electronic device 700 can include one or more of a processing unit 702, a memory 704 or storage device, input devices 706, a display 708, output devices 710, and a power source 712. In some cases, various implementations of the electronic device 700 may lack some or all of these components and/or include additional or alternative components.

The processing unit 702 can control some or all of the operations of the electronic device 700. The processing unit 702 can communicate, either directly or indirectly, with some or all of the components of the electronic device 700. For example, a system bus or other communication mechanism 714 can provide communication between the processing unit 702, the power source 712, the memory 704, the input device(s) 706, and the output device(s) 710.

The processing unit 702 can be implemented as any electronic device capable of processing, receiving, or transmitting data or instructions. For example, the processing unit 702 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 700 can be controlled by multiple processing units. For example, select components of the electronic device 700 (e.g., an input device 706) may be controlled by a first processing unit and other components of the electronic device 700 (e.g., the display 708) may be controlled by a second processing unit, where the first and second processing units may or may not be in communication with each other.

The power source 712 can be implemented with any device capable of providing energy to the electronic device 700. For example, the power source 712 may be one or more batteries or rechargeable batteries. Additionally, or alternatively, the power source 712 can be a power connector or power cord that connects the electronic device 700 to another power source, such as a wall outlet.

The memory 704 can store electronic data that can be used by the electronic device 700. For example, the memory 704 can store electronic data or content such as, for example, audio and video files, documents and applications, device settings and user preferences, timing signals, control signals, and data structures or databases. The memory 704 can be configured as any type of memory. By way of example only, the memory 704 can be implemented as random access memory, read-only memory, flash memory, removable memory, other types of storage elements, or combinations of such devices.

In various embodiments, the display 708 provides a graphical output, for example associated with an operating system, user interface, and/or applications of the electronic device 700 (e.g., a chat user interface, an issue-tracking user interface, an issue-discovery user interface, etc.). In one embodiment, the display 708 includes one or more sensors and is configured as a touch-sensitive (e.g., single-touch, multi-touch) and/or force-sensitive display to receive inputs from a user. For example, the display 708 may be integrated with a touch sensor (e.g., a capacitive touch sensor) and/or a force sensor to provide a touch- and/or force-sensitive display. The display 708 is operably coupled to the processing unit 702 of the electronic device 700.

The display 708 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 708 is positioned beneath and viewable through a cover that forms at least a portion of an enclosure of the electronic device 700.

In various embodiments, the input devices 706 may include any suitable components for detecting inputs. Examples of input devices 706 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 706 may be configured to detect one or more particular types of input and provide a signal (e.g., an input signal) corresponding to the detected input. The signal may be provided, for example, to the processing unit 702.

As discussed above, in some cases, the input device(s) 706 include a touch sensor (e.g., a capacitive touch sensor) integrated with the display 708 to provide a touch-sensitive display. Similarly, in some cases, the input device(s) 706 include a force sensor (e.g., a capacitive force sensor) integrated with the display 708 to provide a force-sensitive display.

The output devices 710 may include any suitable components for providing outputs. Examples of output devices 710 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 710 may be configured to receive one or more signals (e.g., an output signal provided by the processing unit 702) and provide an output corresponding to the signal.

In some cases, input devices 706 and output devices 710 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 702 may be operably coupled to the input devices 706 and the output devices 710. The processing unit 702 may be adapted to exchange signals with the input devices 706 and the output devices 710. For example, the processing unit 702 may receive an input signal from an input device 706 that corresponds to an input detected by the input device 706. The processing unit 702 may interpret the received input signal to determine whether to provide and/or change one or more outputs in response to the input signal. The processing unit 702 may then send an output signal to one or more of the output devices 710, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

Unless otherwise stated, the terms “include” and “comprise” (and variations thereof such as “including,” “includes,” “comprising,” “comprises,” “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

What is claimed is:

1. A method comprising, during a user interaction session with a portal of a content collaboration service:
receiving a portal page request from a user, the portal page request referring to a portal page configured to display a set of recommended content-creation templates to the user;
assigning a user identifier associated with the user to a user class, the user class selected from a set of user classes including:
a first user class indicating that the portal page request includes semantic content from a referring source registered with the content collaboration service;
a second user class indicating that the user is associated with a user account of any software platform of the set of software platforms of the content collaboration service and that the portal page request does not include semantic content from a referring source registered with the content collaboration service; and
a third user class indicating that the user is not associated with a user account of any software platform of the set of software platforms of the content collaboration service and that the portal page request does not include semantic content from a referring source registered with the content collaboration service;
determining a platform intent based at least in part on the user class, the platform intent indicating preference for a software platform of the set of software platforms associated with the content collaboration service, the determining including:
in accordance with a determination that the user identifier is assigned to the first user class, determining the platform intent based at least in part on the semantic content from the referring source;
in accordance with a determination that the user identifier is assigned to the second user class, determining the platform intent based at least in part on content collaboration service usage data associated with the user account of the user; and
in accordance with a determination that the user identifier is assigned to the third user class, determining the platform intent based at least in part on portal activity data of the user during the user interaction session with the portal of the content collaboration service;
selecting a software platform of the set of software platforms based at least in part on the determined platform intent;
identifying a set of candidate content-creation templates associated with the selected software platform;
ranking the set of candidate content-creation templates based at least in part on the user class, the ranking including:
in accordance with a determination that the user identifier is assigned to the first user class, ranking the set of candidate content-creation templates based at least in part on the semantic content from the referring source;
in accordance with a determination that the user identifier is assigned to the second user class, ranking the set of candidate content-creation templates based at least in part on the content collaboration service usage data associated with a user account of the user; and
in accordance with a determination that the user identifier is assigned to the third user class, ranking the set of candidate content-creation templates based at least in part on the portal activity data of the user during the user interaction session with the portal of the content collaboration service; and
causing identifiers of at least a portion of the set of candidate content-creation templates to be displayed on the portal page according to the ranking.

2. The method of claim 1, wherein the content collaboration service usage data associated with the user account of the user includes a content-creation template usage history for the selected software platform.

3. The method of claim 1, further comprising, in response to a user selection of a displayed identifier of a candidate content-creation template of a collaborative document platform:
in accordance with a determination that the user identifier is associated with a user account of the collaborative document platform, displaying a content-creation template interface in the collaborative document platform in an authenticated session; and
in accordance with a determination that the user identifier is not associated with a user account of the collaborative document platform, displaying an account registration interface for the collaborative document platform.

4. The method of claim 3, further comprising:
generating a content item for the collaborative document platform, the content item including the content-creation template;
displaying the content item in the content-creation template interface;
receiving a user modification of the content item; and
storing the user modified content item in association with the collaborative document platform.

5. The method of claim 1, further comprising:
after assigning the user identifier to the third user class, authenticating the user with respect to the content collaboration service; and
in response to authenticating the user with respect to the content collaboration service:
reassigning the user identifier to the second user class;
reranking the set of candidate content-creation templates based at least in part on the content collaboration service usage data associated with the user account of the user; and
causing identifiers of at least a portion of the reranked set of candidate content-creation templates to be displayed on the portal page according to the reranking.

6. The method of claim 1, wherein the semantic content from the referring source includes at least one of:
one or more search query terms provided by the user to the referring source; or
text content that was displayed to the user by the referring source.

7. The method of claim 1, wherein the portal activity data of the user during the user interaction session with the portal of the content collaboration service includes text content from a site visited during the user interaction session.

8. A method comprising, during a user interaction session with a portal of a content collaboration service:
receiving a portal page request from a user, the portal page request referring to a portal page configured to display a set of recommended content-creation templates for a software platform to the user;
assigning a user identifier associated with the user to a user class, the user class selected from a set of user classes including:
a first user class indicating that the portal page request includes search query terms from a referring source;
a second user class indicating that the user is associated with a user account of any software platform of the set of software platforms of the content collaboration service and that the portal page request does not include search query terms from a referring source; and
a third user class indicating that the user is not associated with a user account of any software platform of the set of software platforms of the content collaboration service and that the portal page request does not include search query terms from the referring source;
identifying a set of candidate content-creation templates associated with the software platform;
ranking the set of candidate content-creation templates, including:
in accordance with a determination that the user identifier is assigned to the first user class, ranking the set of candidate content-creation templates based at least in part on the search query terms from the referring source;
in accordance with a determination that the user identifier is assigned to the second user class, ranking the set of candidate content-creation templates based at least in part on content collaboration service usage data associated with the user account; and
in accordance with a determination that the user identifier is assigned to the third user class, ranking the set of candidate content-creation templates based at least in part on portal activity data of the user during the user interaction session with the portal of the content collaboration service; and
causing identifiers of at least a portion of the set of candidate content-creation templates to be displayed on the portal page according to the ranking.

9. The method of claim 8, wherein ranking the set of candidate content-creation templates based at least in part on the content collaboration service usage data associated with the user account comprises ranking the set of candidate content-creation templates based at least in part on a dataset that includes an identifier of at least one content-creation template that was previously used by the user and at least one content item created by the user.

10. The method of claim 8, wherein ranking the set of candidate content-creation templates based at least in part on the search query terms from the referring source includes:
identifying respective semantic content associated with respective content-creation templates;
determining respective semantic similarity scores between the search query terms and the respective semantic content associated with the respective candidate content-creation templates; and
ranking the set of candidate content-creation templates based on the semantic similarity scores.

11. The method of claim 8, wherein the portal activity data of the user during the user interaction session with the portal of the content collaboration service includes textual content from a set of sites visited by the user during the user interaction session.

12. The method of claim 8, further comprising, in response to a user selection of a displayed identifier of a candidate content-creation template of a collaborative document platform:
in accordance with a determination that the user identifier is associated with a user account of the collaborative document platform, displaying a content-creation template interface in the collaborative document platform in an authenticated session; and
in accordance with a determination that the user identifier is not associated with a user account of the collaborative document platform, displaying an account registration interface for the collaborative document platform.

13. The method of claim 8, wherein ranking the set of candidate content-creation templates further includes, in accordance with a determination that the user identifier is assigned to the second user class, ranking the set of candidate content-creation templates further based at least in part on at least one of a team affiliation or a job title associated with the user account.

14. The method of claim 8, wherein:
ranking the set of candidate content-creation templates based at least in part on the search query terms from the referring source comprises ranking the set of candidate content-creation templates with a first template ranking engine configured to rank the set of candidate content-creation templates using a first recommendation model;
ranking the set of candidate content-creation templates based at least in part on content collaboration service usage data associated with the user account comprises ranking the set of candidate content-creation templates with a second template ranking engine configured to rank the set of candidate content-creation templates using a second recommendation model different from the first recommendation model; and
ranking the set of candidate content-creation templates based at least in part on portal activity data of the user during the user interaction session with the portal of the content collaboration service comprises ranking the set of candidate content-creation templates with a third template ranking engine configured to rank the set of candidate content-creation templates using a third recommendation model different from the first and from the second ranking model.

15. The method of claim 14, wherein:
the first recommendation model comprises a semantic similarity model;
the second recommendation model comprises a hybrid matrix factorization model; and
the third recommendation model comprises a sequential recommendation model.

16. A method comprising, during a user interaction session with a portal of a content collaboration service:
receiving a portal page request from a user, the portal page request referring to a portal page configured to display a set of recommended content-creation templates for a software platform to the user;
identifying a set of candidate content-creation templates associated with the software platform;
selecting a template ranking engine for ranking the set of candidate content-creation templates based at least in part on a type of an available dataset for the user, the selecting including:
in accordance with a determination that the available dataset for the user includes semantic content from a referring source, selecting a first template ranking engine;
in accordance with a determination that the available dataset for the user does not include semantic content from a referring source and does include content collaboration service usage data associated with a user account of any software platform of the set of software platforms of the content collaboration service, selecting a second template ranking engine; and
in accordance with a determination that the available dataset for the user includes portal activity data of the user during a user interaction session with the portal of the content collaboration service and does not include semantic content from a referring source and does not include content collaboration service usage data associated with a user account of any software platform of the set of software platforms of the content collaboration service, selecting a third template ranking engine;
ranking the set of candidate content-creation templates using the selected template ranking engine, wherein:
the first template ranking engine is configured to rank the set of candidate content-creation templates based at least in part on the semantic content from the referring source;
the second template ranking engine is configured to rank the set of candidate content-creation templates based at least in part on the content collaboration service usage data associated with the user account; and
the third template ranking engine is configured to rank the set of candidate content-creation templates based at least in part on the portal activity data of the user during the user interaction session with the portal of the content collaboration service; and
causing identifiers of at least a portion of the set of candidate content-creation templates to be displayed on the portal page according to the ranking.

17. The method of claim 16, wherein:
the portal page is configured to display identifiers of a set of recommended content-creation templates for the set of software platforms, the set of software platforms including the software platform; and
the method further comprises, in response to receiving the portal page request from the user, determining a platform intent based at least in part on the type of available dataset for the user, the platform intent indicating preference for a software platform of the set of software platforms associated with the content collaboration service, the determining including:
in accordance with the determination that the available dataset for the user includes semantic content from a referring source, determining the platform intent based at least in part on the semantic content from the referring source;
in accordance with a determination that the available dataset for the user does not include semantic content from a referring source and does include content collaboration service usage data associated with a user account of the content collaboration service, determining the platform intent based at least in part on the content collaboration service usage data associated with the user account; and
in accordance with a determination that the available dataset for the user includes portal activity data of the user during a user interaction session with the portal of the content collaboration service and does not include semantic content from a referring source and does not include content collaboration service usage data associated with a user account of the content collaboration service, determining the platform intent based at least in part on the portal activity data of the user during the user interaction session with the portal of the content collaboration service.

18. The method of claim 16, wherein ranking the set of candidate content-creation templates based at least in part on the content collaboration service usage data associated with the user account comprises ranking the set of candidate content-creation templates based at least in part on a dataset that includes an identifier of at least one content-creation template that was previously used by the user and at least one content item created by the user.

19. The method of claim 16, wherein the semantic content from the referring source includes at least one of a search query provided by the user to the referring source or text content that was displayed to the user by the referring source.

20. The method of claim 16, further comprising, in response to a user selection of a displayed candidate content-creation template of a collaborative document platform:
in accordance with a determination that the user is associated with a user account of the collaborative document platform, displaying a content-creation template interface in the collaborative document platform in an authenticated session; and
in accordance with a determination that the user is not associated with a user account of the collaborative document platform, displaying a trial account registration interface for the collaborative document platform.
